(19) United States
(12) Patent Application Publication
(10) Pub. No.: US 2012/0304248 A1
(43) Pub. Date: Nov. 29, 2012

(54) METHOD AND SYSTEM FOR INFORMATION TECHNOLOGY ASSET MANAGEMENT

(75) Inventors: Gordon Watts, Gloucester (CA); Sébastien Clément, Gatineau (CA)

(73) Assignee: PROVANCE TECHNOLOGIES, INC., GATINEAU, QC (CA)

(21) Appl. No.: 13/501,840

(22) PCT Filed: Oct. 13, 2010
(86) PCT No.: PCT/CA10/01593

§ 371 Date: Aug. 13, 2012

Related U.S. Application Data
(60) Provisional application No. 61/251,148, filed on Oct. 13, 2009.

(51) Int. Cl. G06F 21/24

(52) U.S. Cl. 726/1

(57) ABSTRACT

As aspects of the present invention provides a manner of software asset management involving inputting data pertaining to software into a database; performing software product mapping for software product data input to the database; performing usage rights rule building for usage rights data input to the database; performing software title mapping for software title data input to the database; and determining software compliance as a function of data input to the database and mappings that are performed on the data. Another aspect of the present invention includes method of inputting or importing data into a database m an IT service management system involving: the system importing the data into temporary storage m the database; the system applying validation rules; the system applying the transformation rules; the user reviewing the processed data; the user modifying the processed data; the user requests that the processed data be committed to the database; the system committing the processed data to records in the database.

### FIELD OF THE INVENTION

The invention relates to information technology (IT) asset management.

### BACKGROUND OF THE INVENTION

Enterprises and organizations are increasingly reliant on their technology infrastructure to enable them to conduct business. These networks have become vast and complex, encompassing not only desktop computers, but laptops, personal data assistants (PDAs), servers, Voice-over IP phones, digital cell phones, pagers, and countless other electronic devices. Rapid advances in technology, such as virtualization and cloud computing introduce new IT management challenges. Increasingly, other types of IT-related assets are tracked, such as software licenses, service contracts, and service level agreements. How well an organization is able to actively manage this infrastructure reflects the effectiveness of that organization's ability to do business.

IT organizations face many challenges, critical among these are that they are under pressure to control their costs and be agile.

In the U.S., the Sarbanes-Oxley Act requires companies to keep records of various aspects of IT infrastructure. For purposes of being a good corporate citizen and compliance with copyright laws and licensing agreements, companies would prefer to have a detailed understanding of their IT infrastructure.

IT asset management has previously been performed by manually tracking, for example tagging hardware with bar codes, tracking information regarding hardware and software and storing that information in a conventional database.

Tools were eventually developed for “sniffing” out relevant information on BIOS of a computer. These tools could grab vast amounts of data automatically pertaining to all sorts of facets of hardware and software.

In addition to terms and conditions set forth in end user license agreements (EULAs) provided with software, software licensees are also required to comply with additional and separately specified terms and conditions regarding the appropriate quantity, duration, deployment environments and uses of the software. These additional terms and conditions are determined by product usage rights (PURs), volume purchasing agreements, support and maintenance contracts, laws, regulations, corporate policies and other supplemental contracts and agreements.

Existing solutions do not address the new requirements that have emerged as a result of technical innovation and increased number of factors that determine software license compliance.

### SUMMARY OF THE INVENTION

According to a first aspect of the invention, there is provided a method of monitoring software licensing compliance comprising: inputting data pertaining to software into a database; performing software product mapping for software product data input to the database; performing usage rights rule building for usage rights data input to the database; performing software title mapping for software title data input to the database; determining software compliance as a function of data input to the database and mappings that are performed on the data.

In some embodiments, usage rights comprise any one or more of: data related product use rights (PUR), laws, industry regulations, and organizational policies that may fall outside the realm of an end user licensing agreement for one or more pieces of software.

In some embodiments, performing usage rights rule building for usage rights data input to the database comprises building rules for importing or inputting usage rights data, which is in an unstructured record format, which enables converting the unstructured format into a format that is more acceptable than the unstructured record format for correlating with other data stored in the database.

In some embodiments, inputting data into the database comprises inputting or importing, or both, data related to a purchase of information technology (IT) assets.

In some embodiments, data related to a purchase of IT assets comprises one or more of: an advanced shipping notification (ASN); a purchase order (PO); an invoice; data transfer from financial management systems, a credit card receipt, a cancelled check, and a cash register receipt.

In some embodiments, data related to a purchase of IT assets comprises information pertaining to one or more of: a publisher of software purchased, a title of software purchased, a version of software purchased, a part number, a purchased quantity, a date of purchase, a unit price and a supplier.

In some embodiments, inputting data into the database comprises inputting of data related to the entitlement of the licensee.

In some embodiments, data related to the entitlement of the licensee comprises information related to at least one of: a volume agreement; a software support agreement and a maintenance agreement.

In some embodiments, inputting data into the database comprises inputting or importing, or both, data related to the deployment of software or hardware, or both, in an enterprise network.

In some embodiments, data related to the deployment of software or hardware comprises data that is an inventory of software or hardware, or both, installed on computers or assigned to users in the licensee's environment.

In some embodiments, performing software product mapping for software product data input to the database comprises at least one of: mapping the software product data to data records that are already stored in the database; or creating new data records in the database based on the input/imported software product data.

In some embodiments, performing software title mapping for software title data input to the database comprises: configuring data that is collected either automatically by software inventory, discovery or configuration management software, or manually through physical inventory and imported/input to the database; mapping the configured data to a standardized list indicating the publisher, title and version of the software products.

In some embodiments, the method of monitoring software licensing compliance is included in one of: an IT service management system; and a software asset management system.

According to a second aspect of the invention, there is provided an IT management system comprising: a processor; a computer-readable memory comprising: software modules including computer executable instructions, which when executed by the processor perform the following functionalities: inputting data pertaining to software into a database; performing software product mapping for software product data input to the database; performing usage rights rule building for usage rights data input to the database; performing software title mapping for software title data input to the database; determining software compliance as a function of data input to the database and mappings that are performed on the data; a database for storing data input to the IT management system.

In some embodiments, the software modules perform the method steps of various embodiments described above or detailed below.

According to a third aspect of the invention, there is provided a computer-readable medium comprising computer executable instructions, which when executed by a processor perform the following functionalities: inputting data pertaining to software into a database; performing software product mapping for software product data input to the database; performing usage rights rule building for usage rights data input to the database; performing software title mapping for software title data input to the database; determining software compliance as a function of data input to the database and mappings that are performed on the data.

In some embodiments, the computer executable instructions, when executed by a processor, perform the method steps of various embodiments described above or detailed below.

According to a fourth aspect of the invention, there is provided a method of inputting or importing data into a database in an IT service management system, the method comprising: the system importing the data into temporary storage in the database; the system applying validation rules; the system applying the transformation rules; the user reviewing the processed data; the user modifying the processed data; the user requests that the processed data be committed to the database; the system committing the processed data to records in the database.

In some embodiments, the method further comprises: a user defining a new import format for storing a record in the database and applicable rules for importing the data.

In some embodiments, importing the data into temporary storage in the database comprises importing the data as a batch into the temporary storage in the database.

In some embodiments, defining a new import format for storing a record in the database and applicable rules for importing the data is done through a specialized module of the IT service management system.

In some embodiments, importing the data into temporary storage in the database comprises importing the data using a Linking Framework, CSV Import, product-specific Application Programming Interfaces (API), a Web Services connection, or by other means.

In some embodiments, applying validation rules comprises flagging validation errors.

In some embodiments, steps performed by a user are enabled by workflow processes.

In some embodiments, the workflow processes are configured through a specialized module of the IT service management system.

In some embodiments, the user requesting that the processed data be committed to the database further comprises: if some data is invalid, the user choosing to apply the batch despite the error.

In some embodiments, importing the data comprises importing any one or more of: ASN information, PO information; invoice information; and receiving report information.

In some embodiments, the IT service management system is Microsoft System Center Service Manager.

According to a fifth aspect of the invention, there is provided an IT management system comprising: a processor; a computer-readable memory comprising: software modules including computer executable instructions, which when executed by the processor perform the following functionalities: importing data into temporary storage in the database; applying validation rules; applying transformation rules; allowing a user to review processed data; allowing the user to modify the processed data; once the user has requested that the processed data be committed to the database, committing the processed data to records in the database.

In some embodiments, the software modules perform the method steps of various embodiments described above or detailed below.

According to a sixth aspect of the invention, there is provided a computer-readable medium comprising computer executable instructions, which when executed by a processor perform the following functionalities: importing data into temporary storage in the database; applying validation rules; applying transformation rules; allowing a user to review processed data; allowing the user to modify the processed data; once the user has requested that the processed data be committed to the database, committing the processed data to records in the database.

In some embodiments, the computer executable instructions, when executed by a processor, perform the method steps of various embodiments described above.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the invention will now be described with reference to the attached drawings in which:

FIG. 1 is a block diagram of an IT service management system on which embodiments of the inventions may operate;

FIG. 2 is a block diagram illustrating a variety of information defining software license compliance;

FIG. 3 is a block diagram of an example architecture of a database on which embodiments of the inventions may operate;

FIG. 4 is a flow chart illustrating an example of a method for performing software license management according to some embodiments of the invention;

FIG. 5 is an example of a database structure according to some embodiments of the invention;

FIG. 6 is an example of a form used to input data into a database pertaining to Software title information according to some embodiments of the invention;

FIG. 7A is a screen shot of an IT asset management system user interface according to some embodiments of the invention;

FIG. 7B is an example of a form used to input data into a database for adding a software item into a software catalogue according to some embodiments of the invention;

FIG. 8 is an example of a form used to input data into a database for defining software publisher company information according to some embodiments of the invention;

FIG. 9A is an example of a form used to input data into a database for defining a software product record according to some embodiments of the invention;

FIG. 9B is another example of a form used to input data into a database for defining a software product record according to some embodiments of the invention;

FIGS. 9C and 9D together are an example of a form used to input data into a database for defining software licensing information according to some embodiments of the invention;

FIG. 10 is a screen shot of an IT asset management system user interface according to some embodiments of the invention; and

FIG. 11 is a flow chart illustrating an example of a method for inputting/importing data into a database of an IT service management system according to some embodiments of the invention.

### DETAILED DESCRIPTION OF THE EMBODIMENTS OF THE INVENTION

Aspects of the invention may find uses in a variety of IT management systems. Some embodiments of the invention may be utilized in an IT asset management system that maintains a database of records of hardware (which may include computers, peripheral devices, networks, etc) or software, or both. A particular variant of an IT asset management system is a software management system that allows a business to maintain information regarding software used by a business. Such a software management system may enable the business to determine compliance with software license agreements.

Some embodiments of the invention may be utilized in an IT service management system that pertains to help desk operations Two particular examples of utilizing the invention in an IT service management system include 1) determining if a sufficient inventory of licenses exists before fulfilling a request to install a new software application and 2) selecting one or more hardware assets that have one or more unapproved software applications installed and using a task to create an incident record in the IT service management system requesting the removal of the software. An IT service management system configured with embodiments of the invention may enable a business to determine compliance with software license agreements.

The type of IT management system that embodiments of the invention may be utilized with are implementation specific, IT service management and IT asset management being but two examples thereof.

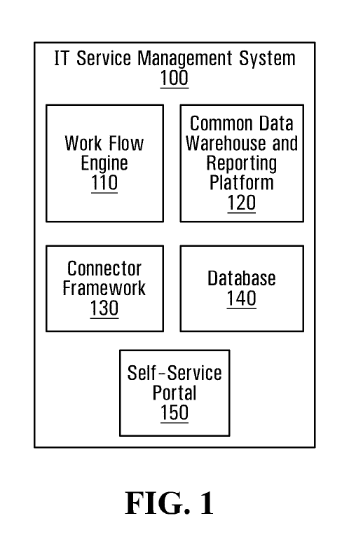

FIG. 1 will be used to describe a particular example of an IT service management system with which some embodiments of the present application may be implemented.

The exemplary IT service management system of FIG. 1 provides some built-in processes, but the system is extensible and flexible in allowing customized modules for providing additional functionality no provided by the built-in processes to be created and implemented with the system. Some embodiments of the invention include different forms of customized modules that may be utilized with such a system.

The IT service management system 100 includes a workflow engine 110, a common data warehouse and reporting platform 120, a connector framework 130 to support technology integration across the system, a database 140 and a self-service portal 150.

In the exemplary system of FIG. 1, the workflow engine 110 is used for automating all or portions of IT processes and for integrating customized modules into the IT service management system. The common data warehouse and reporting platform 120 is used for integrating business intelligence information across the system. The connector framework 130 is used to support technology integration across the system, support other third party products, and support common industry management tools. Some embodiments of the invention provide a manner of inputting or importing, or both, data into the database 140. In some embodiments, modules for inputting or importing, or both, data into the database 140 may be included as part of connector framework 130.

The database 140 is used to support the management of information about IT components and how they relate to one another. In a particular implementation the database is a Configuration Management Database that includes configuration items (CIs) CI is another term for a database record, in which fields of the CI are based on the CI's type, class and attributes. The self-service portal 150 is used to provide end users access to IT resources. Particular example may involve the users selecting and requesting software titles from the software title database or the user requesting approval for a software title and fulfillment being performed using an IT service management system incorporating aspects of the invention described herein. This may reduce help desk call volume.

An IT management system, for example, either an IT service management system or an IT asset management system may be implemented on a computing device comprising at least a processor and memory storage. The memory storage comprises portions of the memory storage for storing computer executable code instructions, that when executed by the processor, perform functionalities described above with regard to an IT management system, as well as functionality described below specific to embodiments of the invention. The memory storage may also include portions of the memory storage for storing computer executable code instructions, that when executed by the processor, perform functionalities used for the standard operating functionality of the computing device.

The computing device on which the IT management system is stored may be one or more servers capable of running the IT management system. The one or more servers may be accessible by one or more users. The one or more users may access the IT management system via a computing device such as a desk top, laptop or possibly a wirelessly enable tablet or the like. The users may access the IT management system via a graphical user interface (GUI) that allows the user to perform data input, data import, and generate reports based on input or imported data. In some implementations the GUI may be web browser based such that a user accesses the IT management system over an intranet or the Internet.

Other portions of the memory storage may be allocated for storing data that is inputted or imported, or both, to the computer device which can be acted upon by the IT management system or modules specific to embodiments of the invention as described below.

The computing device may be connected to, and considered a part of an IT infrastructure. The IT infrastructure includes equipment such as hardware (computers, laptops, PDAs, telephones, peripherals such as printers) and software (owned, fully licensed, partly licensed, usage based, subscription). Also included as part of the IT infrastructure is the physical network to which hardware components of the IT infrastructure are coupled, that is for example a WAN or a LAN, that are either hardwired or wireless.

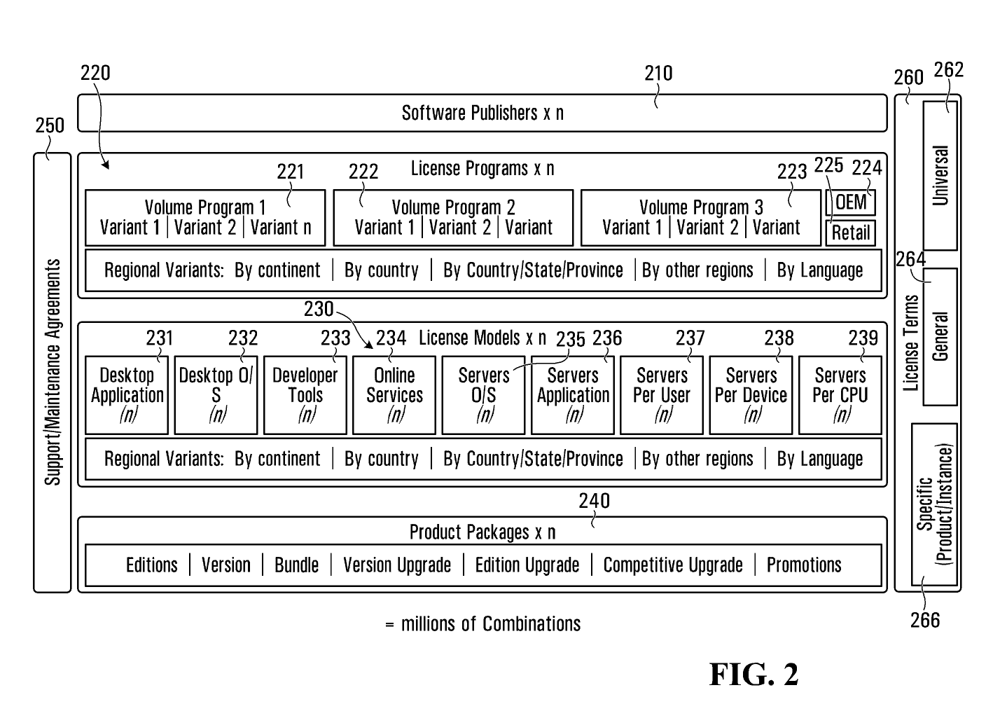

FIG. 2 is a block diagram illustrating an example of the complexity involved in how software may be licensed. Referring to FIG. 2, variables that affect the number of different types of licensing scenarios will now be described. The letter “n” is used in various blocks of FIG. 2, however it is to be understood that “n” is not necessarily intended to be the same number, it is being used to represent the fact that there are more than one. Block 210 indicates that there are multiple software publishers.

Block 220 indicates that there are multiple types of licensing programs. Block 221 is an example of a first volume licensing program having several variations Variant 1, Variant 2, . . . , Variant n. Block 222 is an example of a second volume licensing program having several variations Variant 1, Variant 2, . . . , Variant n. Block 223 is an example of a third volume licensing program having several variations Variant 1, Variant 2, . . . , Variant n. Block 224 is an example of a retail licensing arrangement. Block 225 is an example of an original equipment manufacturer (OEM) licensing program. Furthermore, there may be different licensing programs for different industries such as corporate, health, government academic, charities, developer and partner, may have different licensing arrangements.

Block 230 indicates that there are multiple types of licensing models. Block 231 is an example of multiple licensing models for desktop applications. Block 232 is an example of multiple licensing models for desktop operating system (O/S). Block 233 is an example of multiple licensing models for developer tools. Block 234 is an example of multiple licensing models for online services. Block 235 is an example of multiple licensing models for server operating systems. Block 236 is an example of multiple licensing models for server applications. Block 237 is an example of multiple licensing models for servers per use. Block 238 is an example of multiple licensing models for servers per device. Block 239 is an example of multiple licensing models for servers per CPU. Furthermore, there may be different licensing models for different regions, for example by continent, by country, by county/state/province, by other regions and by language.

Block 240 indicates that there are multiple types of product packages. For example there may be different product packages for different editions, different versions, different bundles, version upgrades, upgrade editions, competitive upgrade and promotions.

Block 250 illustrates that there also may be various support and/or maintenance agreements that can affect how software may be licensed.

Block 260 illustrates that there also may be various licensing terms, such as universal terms 262, general terms 264 and specific product or instance terms 266 that can affect how software may be licensed.

As a result of the various combinations and permutations of the variable affecting software licensing, there are millions of combinations of how the terms of a software license can be defined. Complicating the tracking of software licensing compliance on top of the sheer number of combinations is the fact that the licensing agreements may change frequently, for example as often as every 90 days. Being able to maintain compliance information data in view of the overwhelming amount of information and the frequency of change of that information necessitates systems that are easily adaptable to the information.

Some embodiments of the invention provide modules for an IT management system that enable software licensees to perform one or more of, but not limited to, the following: a) inputting information and importing data from various sources to calculate the licensee's legal, contractual and/or otherwise defined entitlement to, and approved use of software into a computer system; b) converting various structured and unstructured sources of information and data into appropriately structured data for use by a computer system; c) importing preconfigured files of appropriately structured data that provide the necessary information and data; d) using a computer system to calculate the licensee's software entitlement position; e) using a computer system to compare the calculated entitlement with software deployment data to determine the licensee's quantitative conformance; f) determining version, upgrade and/or downgrade rights; g) utilizing a computer system to programmatically check conformance with usage rights specifying the appropriate use of software in the licensee's environment; and h) utilizing a computer system to programmatically check conformance with laws, regulations and corporate policies specifying the appropriate use of software in the licensee's environment.

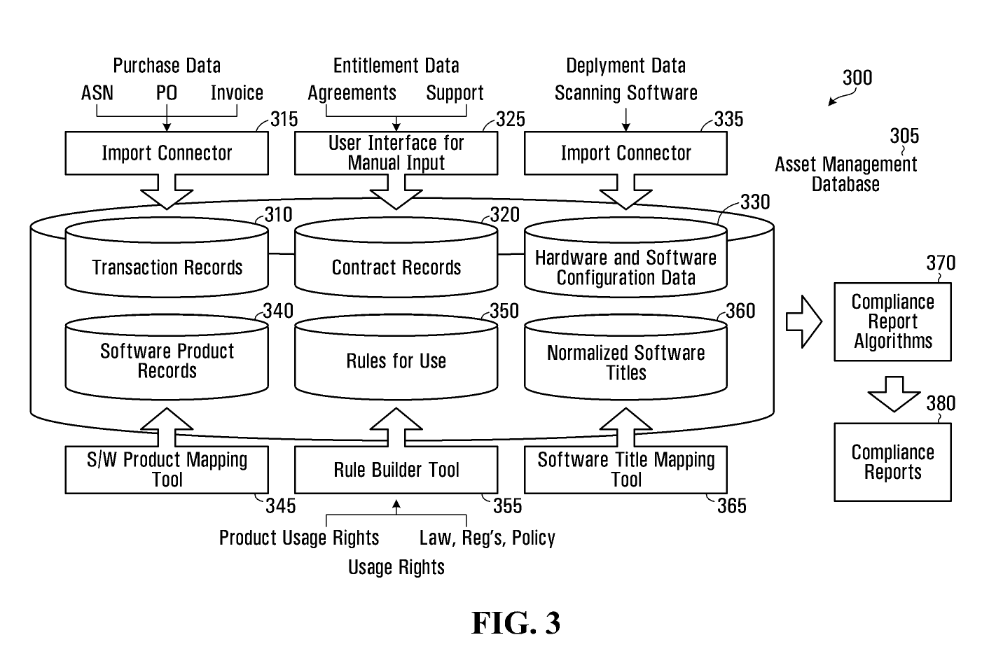

Referring to FIG. 3, a software management architecture will be described that includes modules that interface with a database of an IT management system.

The expression “modules” is used herein to describe algorithms that include computer executable instructions that when executed by a processor of a computing device perform a specific functionality. In some embodiments, the modules are included as part of an overall IT management system. In some embodiments, the modules are available as a group of modules that can be acquired separately from the IT management system for use with such a system. In some embodiments, a plurality of modules, each providing a specific functionality, can be grouped together for providing an added benefit to IT management system. In such embodiments, an end user could select one or more of the plurality of modules to be used with a version of the IT management system that they are using, while deciding not to use other of the modules. In some embodiments, a user selects the plurality of modules to be implemented as a collective group of modules to provide the functionality of all the modules.

With reference to FIG. 3, asset management database 305 is illustrated to include multiple storage elements. A first storage element 310 stores transaction records. A second storage element 320 stores contract records. A third storage element 330 stores hardware and software configuration data. A fourth storage element 340 stores software product records. In some embodiments, the software product records are based at least in part on a part number or stock keeping unit (SKU) number. A fifth storage element 350 stores rules that can be applied to data that is input or imported into the database. A sixth storage element 360 is responsible for storing normalized software titles.

The database 305 can be accessed by compliance report modules 370, which include algorithms used to process the stored data, and the database forward data to the modules 370. The modules can generate compliance reports 380 that detail information such as, but not limited to, publisher, software title, versions of release of each product under license agreement, number of licenses present, number of deployed software instances, proofs of purchase, variance (short/even/over quantity), unit price, total price and comments.

In some embodiments, sources of information and data are input or imported into the database 305 and maintained in the database 305 for the purpose of calculating a licensee's legal, contractual and/or otherwise defined entitlement to, and approved use of software.

A module for inputting or importing data to the first storage element 310 is a first import connector 315. The first import connector 315 enables inputting or importing, or both, of data related to a purchase of IT assets. In some embodiments the IT assets may be software. In some embodiments the IT assets may be hardware, such as, but not limited to, computers computer peripherals, and handheld devices. In some embodiments the IT assets may be other items as well, for example software support purchases, which are support services provided by a software vendor for the software that are purchased in addition to the software or software maintenance purchases. Purchase data includes, but is not limited to, advanced shipping notification (ASN), purchase orders (PO), invoices, and by data transfer from financial management systems. Such data may include details regarding the publisher, title and version of software purchased, part number, purchased quantity, date of purchase, unit price and supplier.

Information in addition to or in lieu of purchase information that establishes the licensee's right to use software may be used as an alternate proof of purchase information. Examples of such alternate proof of purchase may include, but are not limited to: publisher or supplier provided purchase summary reports; certificates of authenticity (such as stickers affixed to hardware or software packaging, or provided as documents); credit card and/or cash register receipts; and cancelled checks.

A module for inputting data to the second storage element 320 is a user interface for manual input 325. The user interface for manual input 325 enables inputting of data related to the entitlement of the licensee. The data related to the entitlement of the licensee may include volume agreements and/or software support and maintenance agreements. Software licensees who commit to purchasing specified quantities of certain software within a given period of time under a Volume Agreement may be subject to different or additional software license conditions. Software licensees who enter into support and/or maintenance contracts for certain software for a given period of time may be subject to different or additional software license conditions.

A module for inputting or importing data to the third storage element 330 is a second import connector 335. The second import connector 335 enables inputting or importing, or both of data related to the deployment of software or hardware, or both, in an enterprise network. Deployed software data is an inventory of software installed on computers or assigned to users in the licensee's environment, collected either automatically by software inventory, discovery or configuration management software, or manually through physical inventory. Deployment data scanning software provides the data of hardware and software deployed on the network.

Hardware configuration data is detailed information about the computers on which software is installed in the licensee's environment, collected either automatically by software inventory, discovery or configuration management software, or manually through physical inventory.

A module for inputting or importing data to the fourth storage element 340 is a software product mapping tool 345. Software product information is not always associated with actual physical items, but may be associated with billing entities. This may be the case for SKUs, in particular. Extended warranties, delivery fees, and installation fees are not physical, but have SKUs because they are billable. Merchants or vendors using a SKU method may have their own approach to assigning the SKU information based on regional or national corporate data storage and retrieval strategies that is different from that of other merchants and vendors. SKU tracking varies from other product tracking methods which are controlled by a wider body of regulations stemming from manufacturers or possibly third-party regulations. Thus the software product mapping tool 345 enables the licensee to map the information in any number of different types of software product information to relevant data records that are already stored in the database or potentially create new data records in the database based on the input/imported software product data.

A module for inputting or importing data to the fifth storage element 350 is a rule builder tool 355. In some implementations, the tool is a “wizard”. A “wizard” is a well known term used to describe conventional means of computer user interfaces. A wizard is typically understood to be an interface that streamlines a process for entering information that may be used for any number of applications. The wizard may have multiple data input fields in which information is received and based on that information an algorithm that the wizard is associated with uses the data to implement a specific functionality, thereby simplifying the work needed to be performed by the user. More generally, what is identified as the wizard interface, can be any user interface that enables a user to input or import data.

The rule builder tool 355 enables importing of data related to usage rights of the licensee. The data related to usage rights may include product use rights (PUR) and laws, industry regulations and/or organizational policies that may fall outside the realm of the end user licensing agreement for a specific piece of software. The usage rights data is often in an unstructured format that is not acceptable to the system and which must be converted to a format that is more acceptable to the IT management system. Usage rights data may include PUR documents that provide use rights information for software acquired under volume agreements. The usage rights data together with the volume agreement under which software is acquired governs the use of the software. Product use rights are regularly updated by software publishers, and are based on a combination of many different factors that change frequently in licensees' environments.

Some example of clauses that define product usage rights include, but are not limited to: a) “This software can be used on one device”; b) “This software can be used by one named user”; c) “This software can be used on a device with 2 CPUs”; d) “This software can be used on a device with 2 CPUs based on Oracle processor core factor counting”; and e) “You are entitled to use version ‘x’ of the software title, as well as any version ‘y’ that is released while you have a valid maintenance and support agreement covering your license”. In some embodiments clauses may be used individually. In some embodiments clauses may be used in combination. In some embodiments the clauses may be used in complex logic constructs, e.g. “if a certain condition exists, you can use it this way; else, you have to use it this way.”

In some embodiments of the invention product usage rights data may be used twice. First the PUR data is used to calculate an entitlement quantity, and second, the PUR data may be used to ensure that deployment of software conforms to all of the specified terms for appropriate use.

Various jurisdictions require software licensees to adhere to legislation governing the use of software, such as restrictions to ensure national security, privacy, environmental protection, etc. Similarly, various bodies have regulatory requirements affecting the use of software by their members, such as industry organizations. Companies, governments and other organizations have standards and policies that prescribe the appropriate deployment and use of software within the entity, e.g. approved and banned software applications.

In some embodiments of the invention, conditions related to legislation governing the use of software or standards and policies that prescribe the appropriate deployment and use of software, or other such terms can be entered as rules and checked by the licensee.

A module for inputting or importing data to the sixth storage element 360 is a software title mapping tool 365. A Software Title List is a standardized list indicating the publisher, title and version of the software products to be evaluated by the licensee. The software title mapping tool 365 enables configuration data that is collected either automatically by software inventory, discovery or configuration management software, or manually through physical inventory and imported/input to the database to be mapped to a standardized list indicating the publisher, title and version of the software products.

Currently, IT management systems are unable to make full use of the vast amount of information that they collect and maintain. For example, a software company that has an IT service management platform that includes monitoring deployment of software and/or hardware, may also produce, market and sell other different types of software for other purposes. The IT service management platform is used to monitor whether businesses using the software supplier's software are in compliance with licensing agreements. However, purchase order information generated in response to the acquisition of software from the software company has a specific format that is not capable of being correlated with information obtained by the monitoring of deployed software and/or hardware performed by the IT service management platform. In some embodiments of the present invention one or more modules are provided for use with such an IT service management platform that enable inputting or importing, or both, of data into the IT service management platform such that the input/imported data can be modified or mapped, or both, within the IT service management platform in a manner that the information is in a format that it can be correlated with deployment information or other types of information.

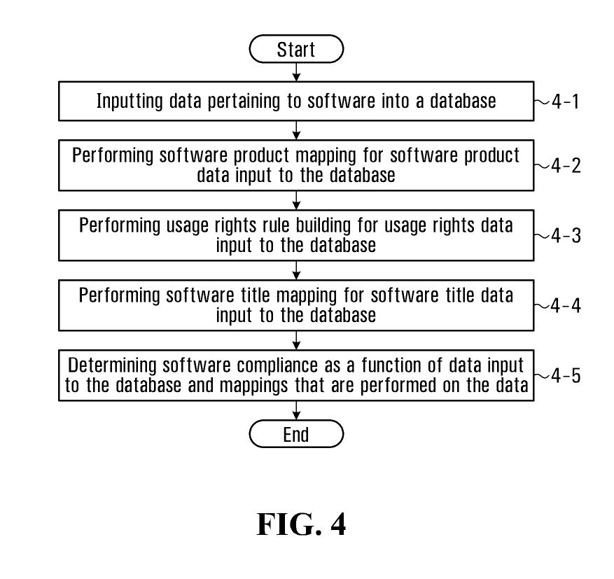

Referring to FIG. 4, an example of a method of monitoring software licensing compliance will now be described.

A first step 4-1 involves inputting data pertaining to software into a database. Data pertaining to software may include: a) usage rights such as, but not limited to, product use rights (PUR), laws, industry regulations and organizational policies that may fall outside the realm of the licensing agreement for a specific piece of software; b) data related to a purchase of IT assets such as, but not limited to, advanced shipping notification (ASN) information, purchase order (PO) information, invoice information, data transfer from financial management systems, credit card receipt information, cancelled check information and cash register receipts; c) data related to the entitlement of the licensee such as, but not limited to, volume agreements, software support agreements and maintenance agreements; d) data related to the deployment of software or hardware, or both, in an enterprise network such as, but not limited to, inventory information of software or hardware, or both, installed on computers or assigned to users in the licensee's environment.

In some embodiments data related to a purchase of IT assets includes information pertaining to one or more of: a publisher of software purchased, a title of software purchased, a version of software purchased, a part number, a purchased quantity, a date of purchase, a unit price and a supplier.

In some embodiments inputting data into the database includes inputting of data related to the entitlement of the licensee. In some embodiments data related to the entitlement of the licensee includes information related to at least one of: a volume agreement; a software support agreement and a maintenance agreement.

In some embodiments, inputting data into the database comprises inputting or importing, or both, data related to the deployment of software or hardware, or both, in an enterprise network. In some embodiments data related to the deployment of software or hardware comprises data that is an inventory of software or hardware, or both, installed on computers or assigned to users in the licensee's environment.

In some embodiments, the data may be imported or input in an unstructured record format than enables converting the unstructured format to a format that is more acceptable for correlating with other data stored in the database.

In some embodiments, some of the data may be imported or input in a structured record format that is acceptable for correlating with other data stored in the database.

A second step 4-2 involves performing software product mapping for software product data input to the database. In some embodiments performing software product mapping for software product data input to the database includes at least one of: mapping the software product data to data records that are already stored in the database; or creating new data records in the database based on the input/imported software product data.

A third step 4-3 involves performing usage rights rule building for usage rights data input to the database. In some embodiments, performing usage rights rule building for usage rights data input to the database includes building rules for importing or inputting usage rights data that is in an unstructured record format that enables converting the unstructured record format into a format that is more acceptable than the unstructured record format for correlating with other data stored in the database.

A fourth step 4-4 involves performing software title mapping for software title data input to the database. In some embodiments performing software title mapping for software title data input to the database includes: configuring data that is collected either automatically by software inventory, discovery or configuration management software, or manually through physical inventory and imported/input to the database; and mapping the configured data to a standardized list indicating the publisher, title and version of the software products.

A fifth step 4-5 involves determining software compliance as a function of data input to the database and mappings that are performed on the data.

In some embodiments an IT management system according to aspects of the invention described herein includes a processor and computer-readable memory. The computer-readable memory includes software modules including computer executable instructions and a database for storing data input to the IT management system. The software modules including computer executable instructions, that when executed by the processor, perform at least one of the following functionalities: inputting data pertaining to software into a database; performing software product mapping for software product data input to the database; performing usage rights rule building for usage rights data input to the database; performing software title mapping for software title data input to the database; determining software compliance as a function of data input to the database and mappings that are performed on the data.

Another aspect of the invention includes a computer-readable medium comprising computer executable instructions, which when executed by a processor perform at least one of the following functionalities: inputting data pertaining to software into a database; performing software product mapping for software product data input to the database; performing usage rights rule building for usage rights data input to the database; performing software title mapping for software title data input to the database; determining software compliance as a function of data input to the database and mappings that are performed on the data.

A computer readable medium may include a physical medium such as a CD, DVD, computer hard drive, random access memory (RAM), read-only memory (ROM) or other conventional means of storing computer-readable information in a computer or on the physical medium to be read and loaded onto a computer.

### Structuring Information and Data for Processing

### Define Software Product List

A software product list is a list of software products that a licensee has acquired. Each software product in the list has an entry with multiple fields that define relevant information regarding the software product. The fields may include information such as, but not limited to, publisher, title, version of the software, volume agreement information, software support and/or maintenance contract information, volume purchase agreement information, manufacturer part number, purchase information and alternate proof of purchase information.

In some embodiments, software product list information is input manually or input by file import of software identified by implementation specific parameters, such as, but not limited to publisher, title and version of the software.

In some embodiments, volume agreement details are sourced from unstructured data in printed or electronic documents. An interface is provided to manually enter and store information from the documents in a computer database.

In some embodiments, software support and/or maintenance contract details are sourced from unstructured data in printed or electronic documents. An interface is provided to manually enter and store the information from the documents in a computer database as structure data for retrieval and processing by the system.

In some embodiments, volume purchase agreement details are stored as unstructured data in printed or electronic documents. An interface is provided to manually enter and store the information from the documents in a computer database for retrieval and processing by the system.

An interface is provided to manually enter or import and store information associated with a manufacturer part number in a computer database for retrieval and processing by the system. The software product mapping tool 345 in FIG. 3 for example, allows information associated with the software represented by the manufacturer part number and purchase information to be related to a single publisher, title and version record in the software product list.

The manufacturer part number may include information such as, but not limited to, publisher, title and version, or other information that may be included in the software product list information.

In some embodiments, an interface is provided to manually enter and store alternate proof of purchase information from a document or other forms of physical evidence in a computer database for retrieval and processing by the system. Information pertaining to the alternate proof of purchase information that may by manually entered may include, but is not limited to, software publisher, title and version, type of alternate proof of purchase (e.g. Certificate of Authenticity, receipt, etc.), the ability to attach the document in question or a link to a file or the description of a physical location of hard copies or materials.

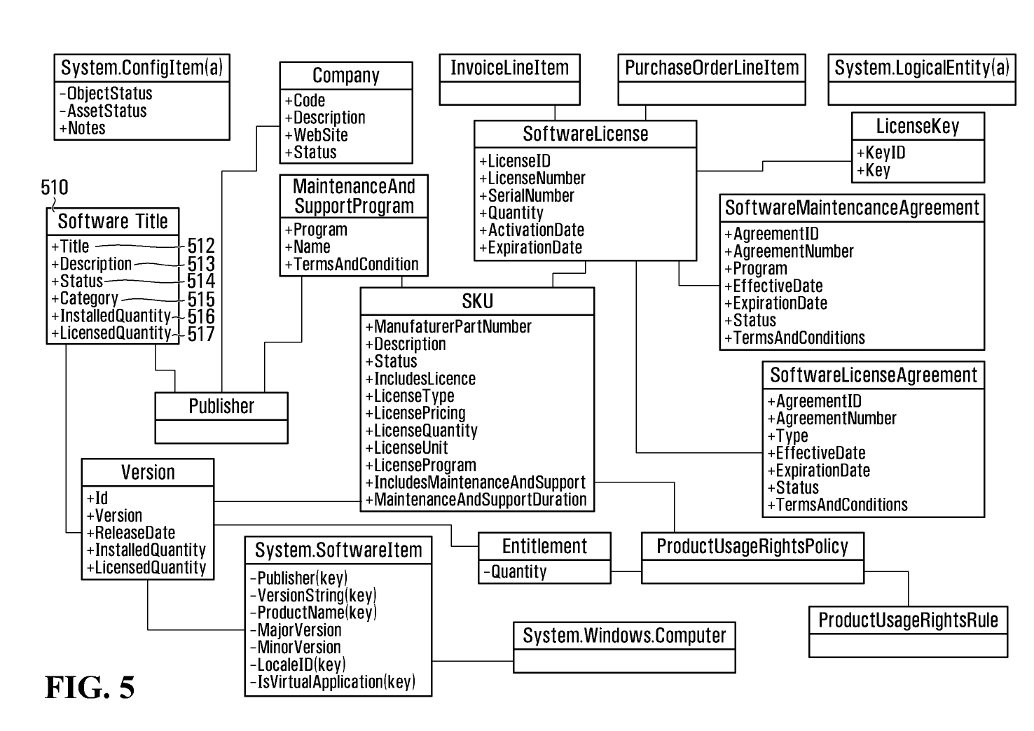

FIG. 5 is a representative example of a database structure defining a logical relationship of the data that is stored in the database. The various blocks in FIG. 5 each have text in a top portion of the respective blocks that defines the data in the block. For example, the block with “Software Title” 510 in the top portion of the block pertains to data related to a software title. A majority of the blocks each contain a list of fields that include data pertaining to the data in that block. For example, “Software Title” block 510 in the top portion of the block includes a list of fields as follows: title 512, description 513, status 514, category 515, installed quantity 516 and licensed quantity 517.

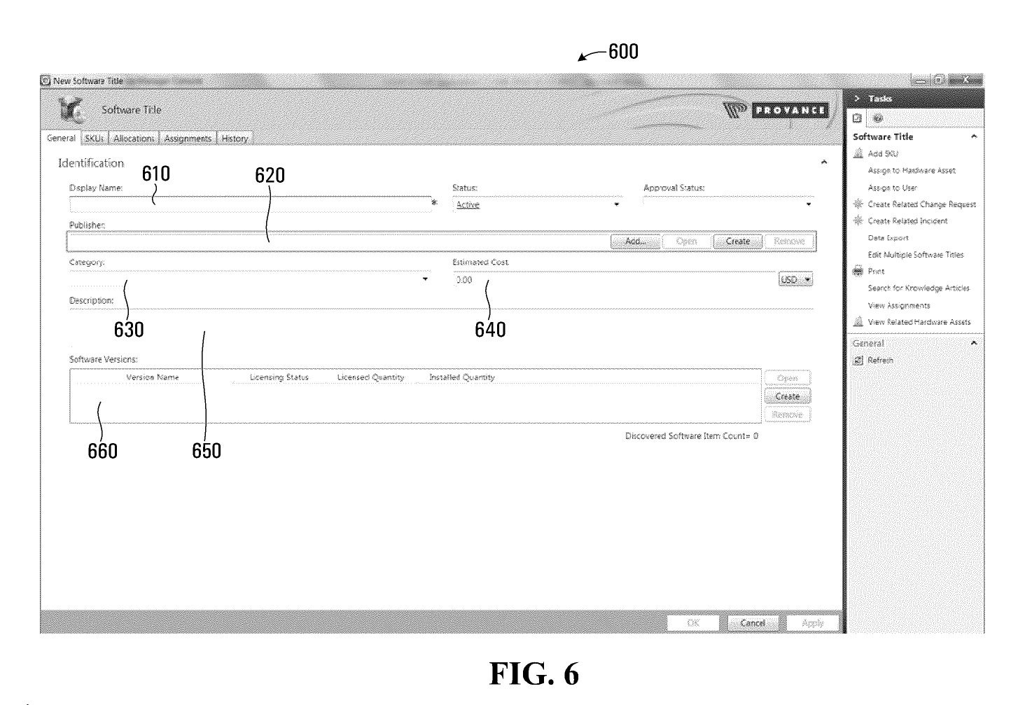

In the description below reference is made to “forms”. This is a term being used to describe a conventional means of computer user interface in for example a graphical user interface that allows a user to input data. A form is typically intended to be a single page user interface for the user to enter data. FIGS. 6A, 8, 9A, 9B, 9C and 9D, described in further detail below, illustrate examples of forms in screen shots of a graphical user interface of an IT management system operating in a manner consistent with embodiments of the invention. More generally, what is identified as a form, can be any user interface that enables a user to input or import data.

### Define a New Software Title for Compliance Management

Some embodiments the invention enable defining information for new software for which software compliance is to be managed. In essence, a subset of a global catalogue that may exist in the database is built to accommodate information that may not have been previously stored in the database.

In a particular example, a user, possibly a licensee who is managing their compliance of software licensing, will navigate to a software catalogue node and select “Create software title” from a task menu. The user will be offered a choice of adding a title by entering information describing the software, or by extracting info from input/imported deployment data. Information defining the software may include, but is not limited to, software title, description, publisher (select from list or create a new one), category, version information that tracks a version string and a release date for every version that is tracked.

FIG. 6 is an example of a form 600 in a screen shot of an IT management system graphical user interface used to manually input data. The form 600 allows for a user to input the information identifying a software title. For example, the user can enter a name for the software 610, the publisher 620, category 630, estimate cost 640, description 650 and software version 660.

### Establish Mappings Between Software Catalogue and Discovery Information

When viewing the software title information, such as in a UI form, the user may be able to select a version number of a software application and open a version mapping form that allows the user to select one or more software items from data being imported that corresponds to the given version of the software. The selection of software items is not necessarily made using a standard instance picker, but rather may be a search form that will allow the user to filter entries available for selection based on, for example publisher or title.

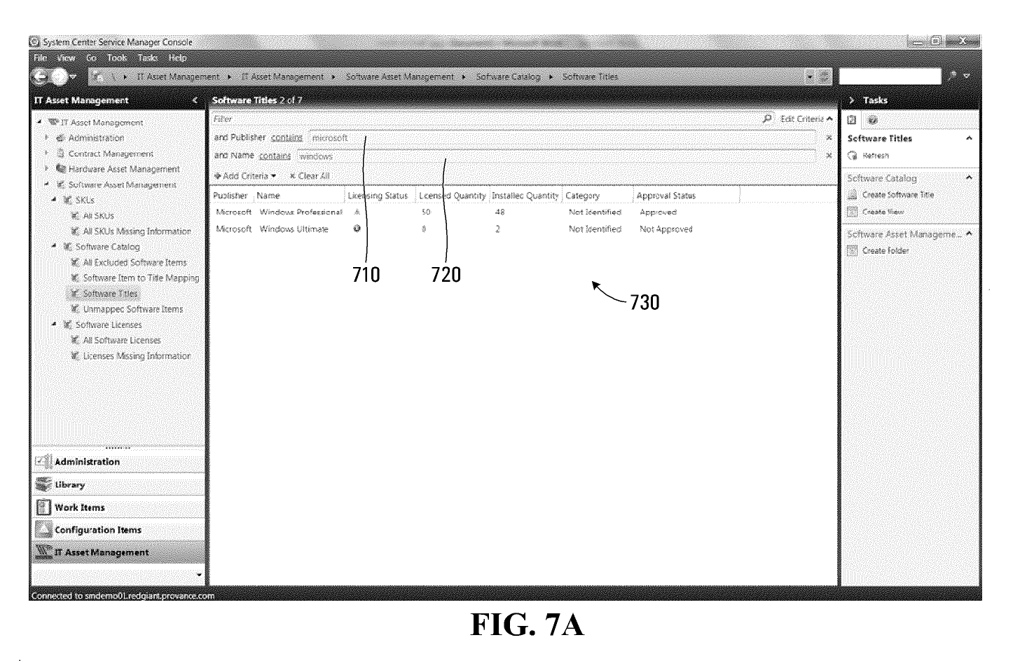

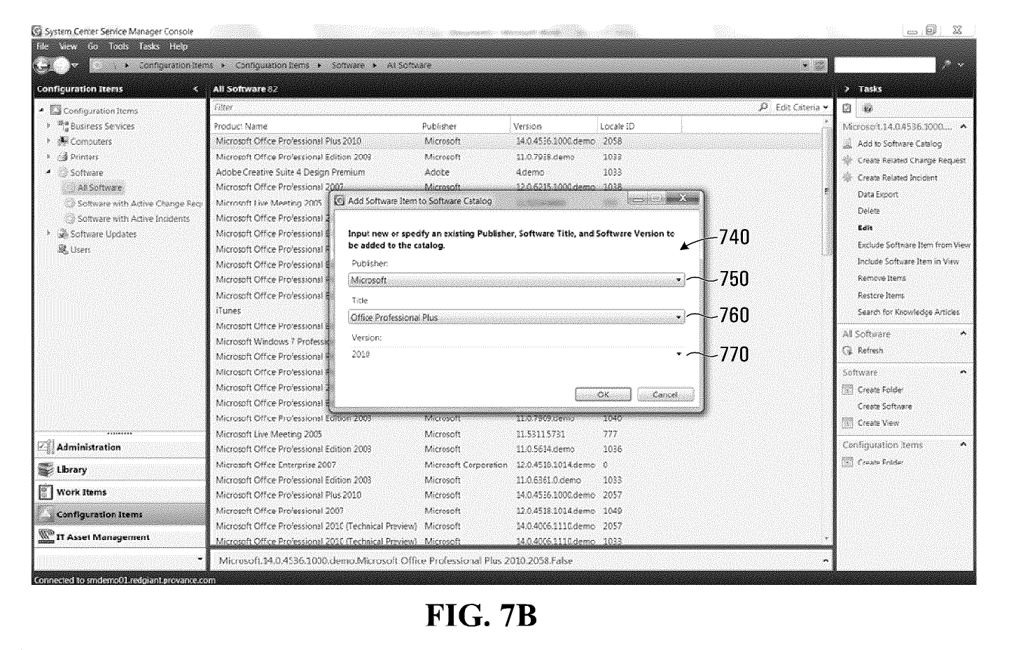

FIG. 7A is a screen shot of an IT management system graphical user interface illustrating how a search can be performed by filtering entries in a database based on entering a publisher name in field 710 and a product name in field 720. Entries that meet the criteria of the entries are displayed in area 730, which displays the results based on publisher, software name, licensing status, licensing quantity, installed quantity, category and approval status. The heading in the area are implementation specific and can be configured to display information desired by the user. In addition, the filtering can be performed based on any of the headings displaying in area 730 for which the user desires to search.

FIG. 7B is an example of a form 740 in a screen shot of an IT management system graphical user interface used to manually input data. The form 740 allows for a user to establish a mapping between a software catalogue and information that may be input or imported to the database. For example in FIG. 7B, there are dropdown menus to allow the user to input information pertaining to the publisher 750, title 760 and version 770 of the software.

### Define Multiple Software Titles and Discovery Mappings in a Single Wizard

In some embodiments, a wizard may be used to allow a system administrator, or other user, to select multiple software titles and versions of software to be created by browsing the data being imported, identifying required titles and defining mappings to one or multiple data items being imported.

### Manage Publishers

In some embodiments, the user can add and edit software publisher information. For example, the user can mark the publisher as inactive when appropriate. In some instances, information captured about a software publisher may be the same as the information captured about a software manufacturer.

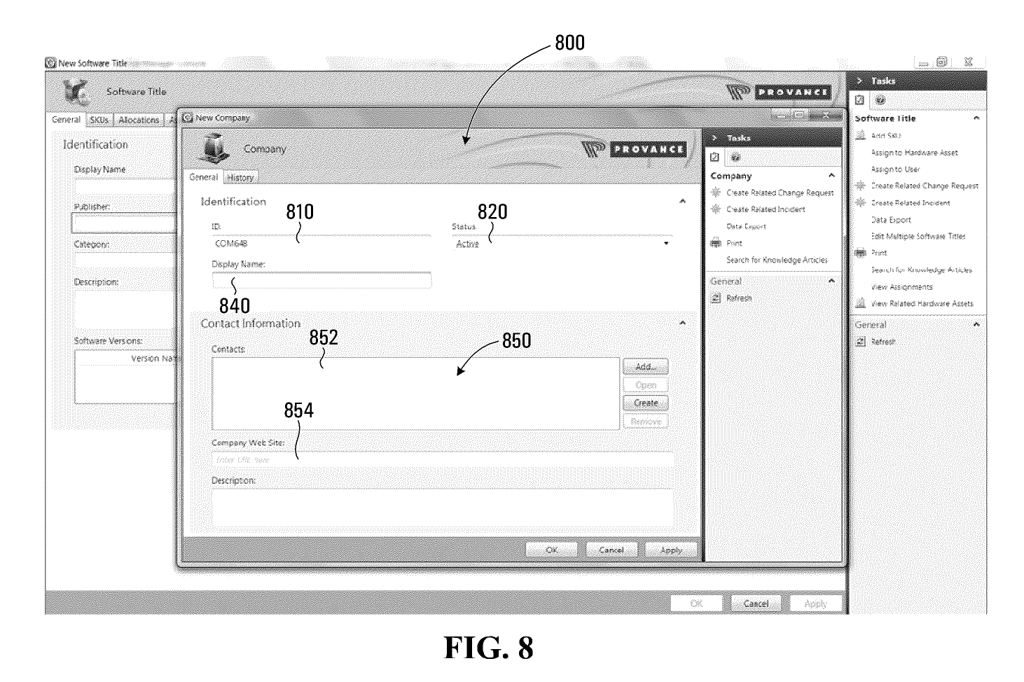

FIG. 8 is an example of a form 800 in a screen shot of an IT management system graphical user interface used to manually input data. The form 800 includes fields to allow the user to define publisher information to be recorded in the database. For example in FIG. 8, there are fields to allow the user to input information pertaining to the company ID of the publisher 810, status 820, the name to be displayed in the database of the company 840, and contact information 850 for the company including contacts 852 and company website 854.

### Create a Software Product Record (SKU)

In some embodiments, creating a new software product record may be done by using a form. A “Create SKU” task may be available when a view of all SKUs is selected in the platform UI.

The form is enabled to accept data for one or more of, but not limited to, the following fields: publisher; publisher part number; description; license type; software title; version; approximate price; and licensing program.

In some implementations, in the license type field, the user may select from a drop-down list of types such as, but not limited to: shrink-wrap; volume; and upgrade. In the software title field, the user may select from previously defined software titles. In some embodiments, in the version field, the user may select from a drop-down list updated to list only versions corresponding to the selected title. In some implementations, in the license type field, the user may select from a drop-down list of licensing programs.

A further section of the form may have fields for the user to enter at least some of the following licensing conditions, such as, but not limited to the following fields: licensing metric; quantity; unit (drop-down list of licensing units such as: named user, CPU, device); and a checkbox to determine if this is an upgrade license. If the checkbox is checked, there may be a list view listing the software titles and versions or editions that can upgraded from. In some embodiments, when adding entries to this list, it may be done with a dialog box that has software title and version fields. In some instances the software title field is pre-populated but overridable.

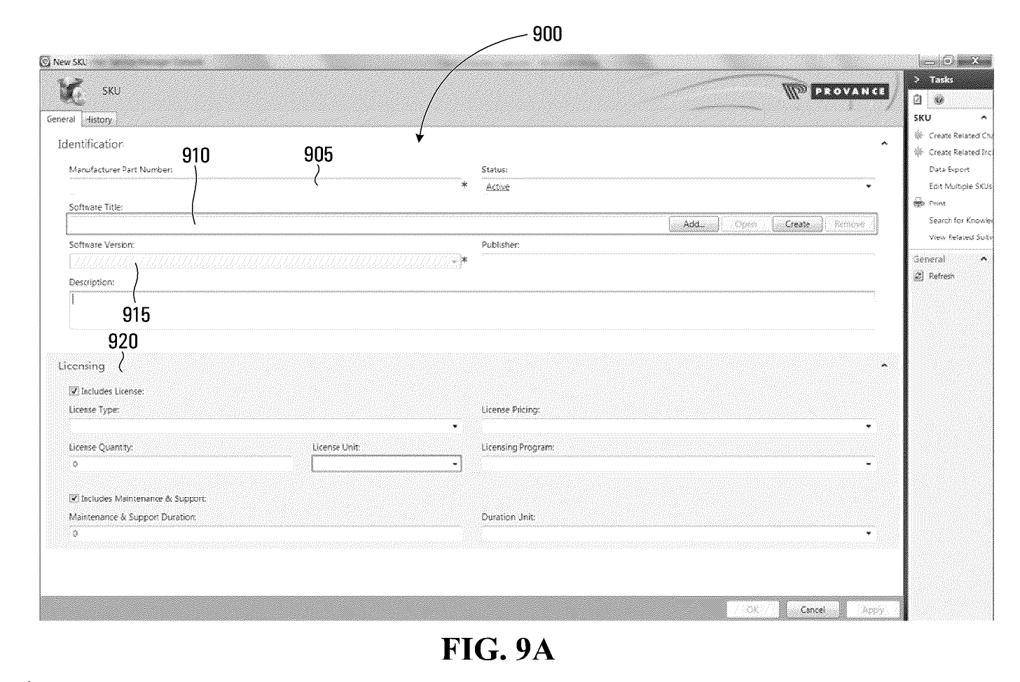

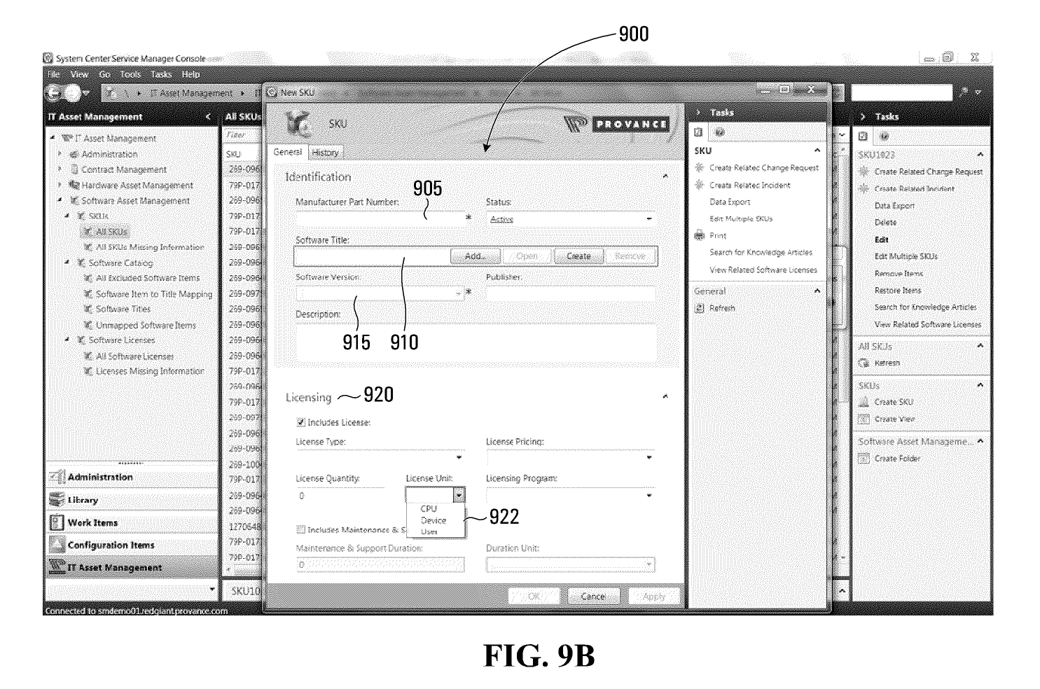

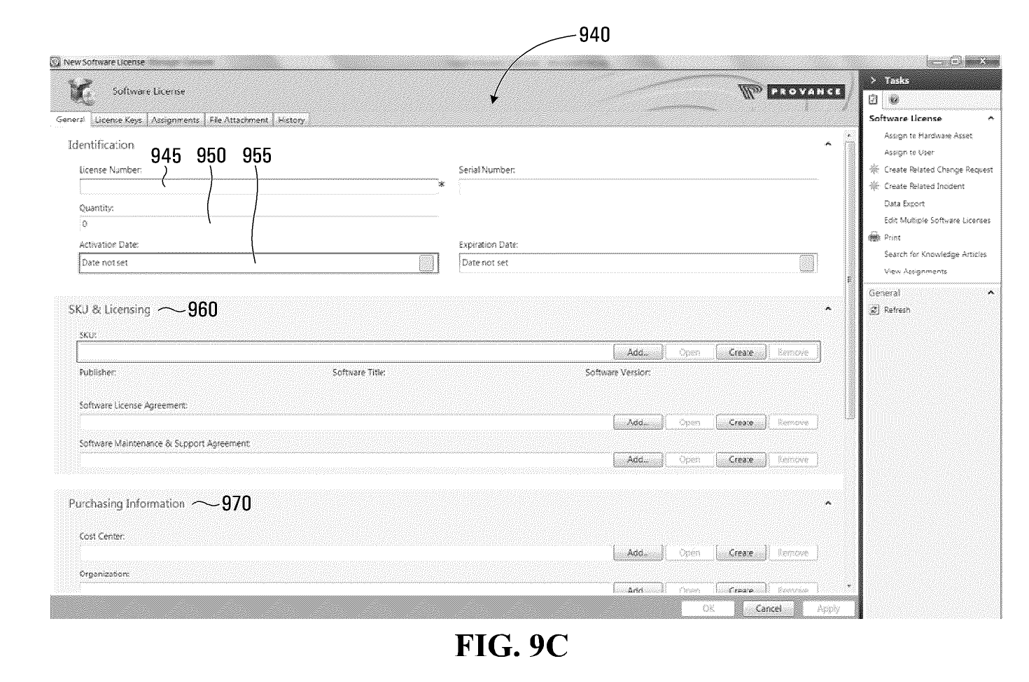

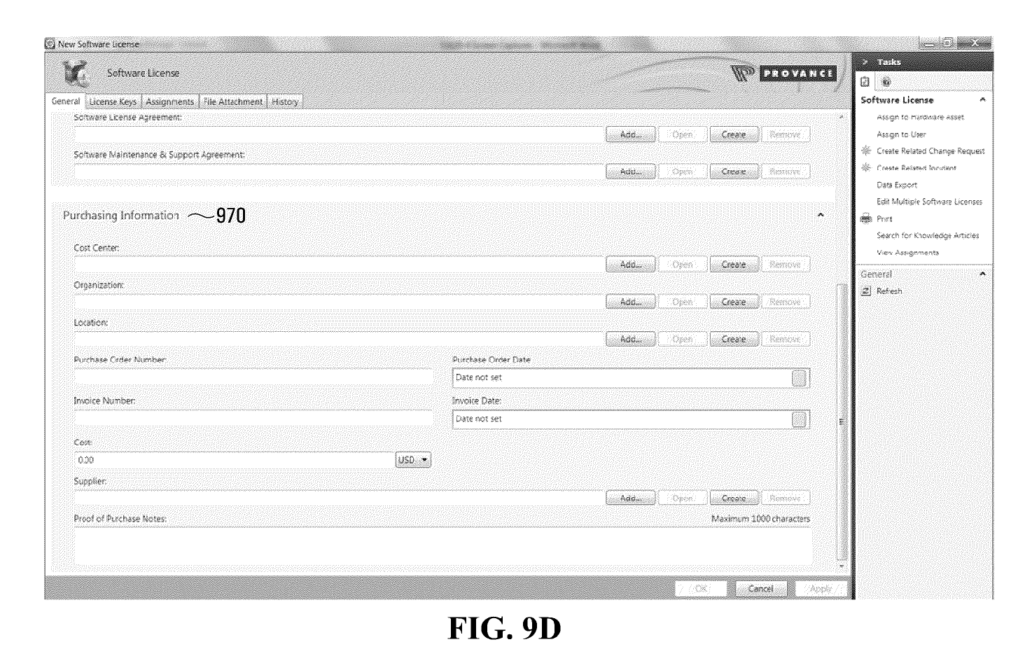

FIG. 9A is an example of a form 900 in a screen shot of an IT management system graphical user interface used to manually input data. The form 900 includes fields to allow the user to define software product record that includes information about the software, such as a manufacturer part number 905, software title 910, software version 915, and licensing 920 information to be recorded in the database.

FIG. 9B is a further view of what is shown in FIG. 9A in which in the licensing 920 information section a pull down menu 922 is shown illustrating how a Licensing Unit selection is made by selecting from one of the options: CPU; Device; and User.

FIGS. 9C and 9D are examples of a form 940 in a screen shot of an IT management system graphical user interface used to manually inputting data. The form 940 allows for a user to define further information about the software license, such as license number 945, quantity 950, activation date 955, SKU information 960 and purchasing information 970. The two figures display the entire form, wherein FIG. 9D is the top portion of the form and FIG. 9E is the bottom portion of the form. There is some overlap in what is displayed in the two figures.

The further section of the form may also have a checkbox to determine if a license grants downgrade rights. If the checkbox is checked, there may be a list view listing the software titles and versions or editions that you can downgrade from. When adding entries to such a list, it may be done with a dialog box that has the software title and version fields. In some instances the software title field is pre-populated but overridable.

Once the form is completed, the software product record is created.

The above is a specific example and it is to be understood that embodiments of the invention may deviate from the scope of the specific description above in an implementation specific manner.

### Edit PUR

In some embodiments of the inventions is possible to change the PUR on multiple software product records.

### Managing Entitlements

Managing entitlements may consist of recording information about the license transactions that have occurred. A goal is to establish a list of what the licensee has acquired. The following are a list of non-limiting examples of what data can be captured and what can be done with the information: a) manually capturing the details of a software purchase; b) importing the details of a software purchase; c) verifying the number of licenses that the licensee is entitled to deploy for a given software title and version; d) generating a report listing all the software titles and versions that the licensee is managing, with corresponding entitlement lists.

### Manually Capture the Details of a Software Transaction (Create Software License Wizard)

The licensee can capture details of a software purchase or existing license for which there is no proof of purchase, but the licensee has a license certificate. In a particular example in which the user is accessing a graphical user interface (GUI) that is part of an IT management system, the user navigates within the GUI to a license transaction selection and selects an option that enable the user to add a license purchase.

This brings up a form for which the user takes the following steps:

a) Entering one or more of, but not limited to, a publisher (option to “Create New”), quantity purchased, vendor, purchase price, invoice number, invoice date, purchase order number, purchase order date, serial number, installation key and software agreement. Some of the fields identified above may be optional, while others are mandatory for advancing on to further stages while using the wizard. In some embodiments, the user may have the option of choosing between entering the publisher and/or vendor software product record, part number or SKU, or selecting a software title and version.

b) If the user enters a publisher or vendor software product record, and the software product record already exists, the wizard determines that no inputting of data should be performed to avoid duplication of information and the wizard is completed.

c) If the user does not enter a Software Product record, and only selects a software title and version, the form may present a list of software product records that apply to this software title and version. The user may select an appropriate software product record or choose not to enter a software product record. In the list of software product records presented to the user for selection, information such as, but not limited to, the license type, licensing unit, licensing quantity and upgrade type may be displayed in the software product records. If the user selects an appropriate software product record, the wizard is completed.

d) If the user does not enter or select a software product record, a field or fields in the form may be presented to allow the user to capture the details of the license entitlements associated with the transactions. The fields presented in the form may be one or more fields used to define a software product record. Preferably, at least the following information may be captured: licensing unit, licensing quantity, and whether software maintenance is included.

The above is a specific example and it is to be understood that embodiments of the invention may deviate from the scope of the specific description above in an implementation specific manner.

### Calculate License Entitlements

In some embodiments, calculations are performed automatically whenever software transactions are created/edited/deleted.

In some implementations, the software product record determines a set of license conditions applicable to each product covered by the software product record. These conditions are used in calculating the entitlements.

### Managing Compliance

### View Instance Counts for a Given Software Title

In a particular example in which the user is accessing a GUI that is part of an IT management system, the user selects a software title and opens up a form. The user sees a count of the installations discovered or manually created for each version of the software title.

### View License Entitlements and Instance Counts for a Given Software Title

In some embodiments, the user accessing a GUI that is part of an IT management system may select a software title and open up a form. The user sees the total calculated quantity of license units available for each version of this title, as well as a count of the installations discovered or manually created for each version. In some embodiments, highlighting the status of the quantity of licenses units available is provided with a configurable threshold for defining whether a calculated quantity of license units available for each version of the software title is less than, within a specified percentage, or greatly exceeds by a specified percentage, the count of installations of the software by the licensee.

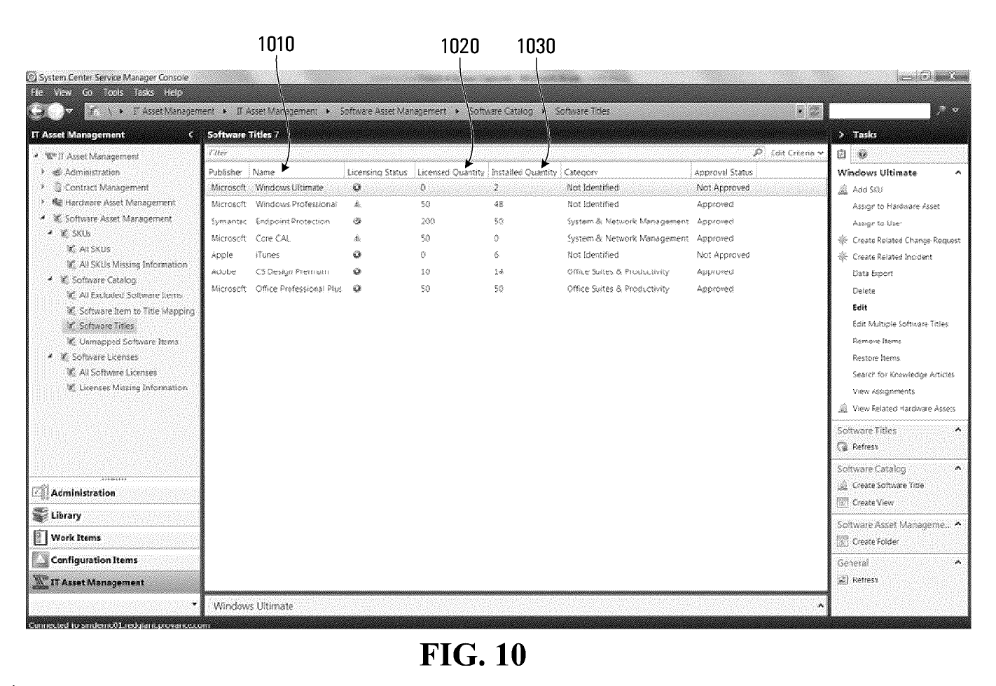

FIG. 10 is a screen shot of an IT management system graphical user interface illustrating license entitlements and instance counts for multiple software titles. The software title can be identified in the “Name” column 1010. The quantity of licensed units are in the “Licensed Quantity” column 1020 and the quantity of installed units is in the quantity is the “Installed Quantity” column 1030.

Other aspects of managing compliance may involve identifying software licenses without proof of purchase and performing licensing compliance reports.

### Supporting IT Management Processes

### Install Software

In some embodiments, the user accessing a GUI that is part of an IT management system wants to install a software title on a user device. The user navigates to the software catalogue branch of the GUI, filters a list including software titles to view a title the user is interested in and opens up the software title form. From the information in the form the user can determine a number of units licensed for each version of the software, as well as a number of installations of this software that were discovered. The user can then confirm the availability of licenses. On the form the user can also determine license keys and serial numbers associated with various transactions.

### Example of Entitlement and Compliance Calculations

The following tables are used to explain examples of software entitlement based on licensing agreements and compliance with those agreements. The tables may be reflective of what is provided in a compliance report. A first column “Software Title” in the tables below indicates particular software titles for which the examples apply. A second column “Version” is a specific version of the software. Subsequent columns “Licensed Quantity”, Deployed Quantity”, “Status” and “Downgrade to” pertain to a number of licenses to which the licensee is entitled based on the agreement, how many instances of the application are deployed by the licensee, the number of licenses that the licensee is over the entitled amount (negative number) or under the entitled amount (positive number).

Table 1 illustrates entitlement for 10 copies of Adobe Acrobat 8 prior to any additional purchases.

TABLE 1
Initial entitlement

| | | Licensed | Deployed |
|---|---|---|---|
| Software Title | Version | Quantity | Quantity |
| Adobe Acrobat | 8 | 10 | 10 |
| Standard | | | |

After the purchase of 6 copies of “Adobe Acrobat Standard (version 9)—version upgrade package”, the table is update as in Table 2 below.

TABLE 2
Entitlement after purchase

| | | Licensed | Deployed |
|---|---|---|---|
| Software Title | Version | Quantity | Quantity |
| Adobe Acrobat | 8 | 4 | 10 |
| Standard | | | |
| Adobe Acrobat | 9 | 6 | 0 |
| Standard | | | |

After the purchase of 3 copies of “Adobe Acrobat Pro—(v. 9)—product upgrade license”, the table is update as in Table 3 below.

TABLE 3
Entitlement after purchase

| | | Licensed | Deployed |
|---|---|---|---|
| Software Title | Version | Quantity | Quantity |
| Adobe Acrobat | 8 | 4 (* 6 are | 10 |
| Standard | | underlying) | |
| Adobe Acrobat | 9 or less | 3 | 0 |
| Standard | | | |
| Adobe Acrobat | 9 or less or | 3 | 0 |
| Professional | standard | | |

Subsequent to the purchases being made, but before any of the new copies have been deployed, a compliance report can be run. If downgrade rights were not being used, then the compliance report may be appear of in Table 4 below.

TABLE 4
Compliance report downgrade right not applied

| Software | | Licensed | Deployed | |
|---|---|---|---|---|
| Title | Version | Quantity | Quantity | Over/Under |
| Adobe | 8 | 4 | 10 | −6 |
| Acrobat | | | | |
| Standard | | | | |
| Adobe | 9 | 3 | 0 | +3 |
| Acrobat | | | | |
| Standard | | | | |
| Adobe | 9 | 3 | 0 | +3 |
| Acrobat | | | | |
| Professional | | | | |

If downgrade rights are applied to the entitlements (part of compliance PUR processing), then the compliance report may be appear of in Table 5 below.

TABLE 5
Compliance report downgrade rights applied

| Software | | Licensed | Deployed | |
|---|---|---|---|---|
| Title | Version | Quantity | Quantity | Over/Under |
| Adobe | 8 | 4 | 10 (−6) | 0 |
| Acrobat | | | | |
| Standard | | | | |
| Adobe | 9 | 3 | 0 (3) | 0 |
| Acrobat | | | | |
| Standard | | | | |
| Adobe | 9 | 3 | 0 (3) | 0 |
| Acrobat | | | | |
| Professional | | | | |

After a period of time during which some of the new purchased copies of software are deployed, the entitlement may be as described in Tables 6 and 7 below, in which Table 7 illustrates how the software is allowed to be downgraded.

TABLE 6
Entitlements after deployment

| Software | | Licensed | Deployed | |
|---|---|---|---|---|
| Title | Version | Quantity | Quantity | Over/Under |
| Adobe | 8 | 4 | 7 (−3) | 0 |
| Acrobat | | | | |
| Standard | | | | |
| Adobe | 9 | 3 | 2 (1) | 0 |
| Acrobat | | | | |
| Standard | | | | |
| Adobe | 9 | 3 | 1 (2) | 0 |
| Acrobat | | | | |
| Professional | | | | |

TABLE 7
Downgrade allowance based on licenses

| Software Title | Version | Downgrade to |
|---|---|---|
| Adobe Acrobat | 9 | Adobe Acrobat |
| Professional | | Professional 8 |
| Adobe Acrobat | 9 | Adobe Acrobat |
| Professional | | Standard 9 |
| Adobe Acrobat | 9 | Adobe Acrobat |
| Professional | | Standard 8 |
| Adobe Acrobat | 9 | Adobe Acrobat |
| Standard | | Standard 8 |

After attempting to match a deployed version of the software with a corresponding entitlement and after applying the downgrade rights, a compliance report may be generated as described in Table 8 below.

TABLE 8
Compliance report downgrade rights applied

| Software | | Licensed | Deployed | |
|---|---|---|---|---|
| Title | Version | Quantity | Quantity | Over/Under |
| Adobe | 8 | 4 | 7 | −3 |
| Acrobat | | | | |
| Standard | | | | |
| Adobe | 9 | 3 | 2 | +1 |
| Acrobat | | | | |
| Standard | | | | |
| Adobe | 9 | 3 | 1 | +2 |
| Acrobat | | | | |
| Professional | | | | |

### Implementation Example

The following is an example of how various aspects of the invention may be used in conjunction with an overall IT management system.

### Scenario Background

Earl Energy Co. is a large, publicly traded, U.S.-based electrical and natural gas utility with approximately 17,500 employees. The IT organization supports 12,000 desktop and laptop PCs mainly located in three states across the Southern U.S.

Within the past year, the company has experienced three software publisher audits by three well known software suppliers with largely favourable results; however, each audit proved to be extremely time consuming and disruptive to both IT and business activities. Furthermore, as a publicly traded company that is proud of its commitment to ethics and compliance, Earl Energy seeks to avoid damage to its reputation and impairment to its acquisition activities by implementing a proactive license compliance program. Brigitte Dee, previously responsible for workstation asset management, has been appointed to the new role of Software Asset Manager. She has been tasked with reducing risk and lost productivity by ensuring that Earl Energy can quickly and successfully respond to future software audits. Brigitte is hoping to achieve this objective by establishing good process and by having accurate, up to date license information and materials readily available.

### High-Level User Scenarios

### 1. Collect and Organize License Compliance Information

Brigitte begins her organization of the license compliance program by collecting and organizing the minimum required information and materials needed to establish and prove compliance: The company's Software license agreements with key publishers; proof of purchase documentation (for example paid invoices); software licenses describing the terms and conditions of use; and an inventory of the software installed on all of Earl Energy's computers.

Brigitte seeks to centrally store the information she has collected as electronic data and automate the gathering and updating of the data as much as possible. Her IT management colleagues have advised Brigitte that modules corresponding to the present invention can be used with an IT management product they use to provide a data repository that will allow Brigitte to store, manage and report on the compliance information she has gathered. Furthermore, some of the modules of the present invention allow Brigitte to automate the collection of data from other systems, saving significant manual effort and time, and decreasing the likelihood of error. Specifically, the modules allow Brigitte to perform one or more of:

a) setting up automated import of invoice data directly from files (for example .CSV files) generated by Earl's finance system;
b) using automatically discovered software and hardware inventory information provided by configuration scanning software;
c) automatically importing key data from Earl's one or more volume license agreements directly from a software supplier's portal or a provided file; and
d) automatically populating license terms and conditions for some software titles without having to review, interpret and manually enter product usage rights details.

### 2. Identify Missing Information

Once Brigitte has entered the license compliance data she has gathered for use by modules provided by embodiments of the invention, she wants to know if there is any information missing that she should find and add to the system. In particular, Brigitte may attempt to identify one or more of, but not limited to:

a) software licenses lacking proof of purchase information;
b) software licenses not accounted for by an agreement; and
c) hardware inventory (computers) that requires manual collection of software information (i.e. in storage, on repair, etc.)

### 3. Perform Physical Inventory of Offline Hardware

In order to ensure she has a complete inventory of software installed on all of Earl's computers, Brigitte generates a list of computers that were not scanned or not recently scanned by the configuration scanning software. The list is used to manually identify computers that need to be analyzed to identify software installed on each such computer and enter the data into the modules.

### 4. Determine Baseline License Compliance Status/Perform Self-Audit

When she is satisfied she has captured sufficient data, Brigitte determines Earl's initial baseline level of license compliance. She generates a proof of purchase summary report that combines both automated and manually collected data to show the total number of software installations on Earl's computers for each title; the total number of licenses and the total number of proofs of purchase for each software title; and the difference (even/over/under) between the count of software installations and proof of purchase counts.

Subsequent to determining initial baseline compliance status, Brigitte will perform the same process at regular intervals (as determined by good practice) to generate self-audits; i.e., she will update the license proof of purchase and installed software data, generate the report and compare the results with the previous baseline and self-audits.

### 5. Source Alternate Proof of Purchase Information

Brigitte identifies a number of software licenses that Earl Energy has purchased and recorded as valid licenses but that lack definitive proof of purchase, i.e. an invoice record. Brigitte is able to source alternate information that she wishes to use as evidence that the software is legitimately licensed, such as, but not limited to, the following examples:

a) license entitlement information from software supplier's portal;
b) vendor purchase summary reports, provided by Earl's distributors;
c) certificates of authenticity, located as stickers affixed to hardware or software packaging, or provided as documents;
d) credit card and/or cash register receipts; and
e) cancelled cheques.

Brigitte wishes to capture and associate key details of the alternate proof of purchase (such as type, serial number or key, etc.) with the software license record and be able to attach a document file, insert a link to a file, and/or specify the physical location of hard copies or materials.

### 7. License Reconciliation

After the baseline compliance audit or a subsequent self-audit, Brigitte identifies a number of software titles that are under licensed (i.e. that lack proof of purchase). After ensuring that the under licensing cannot be resolved by reconciling errors in the license agreement and/or proof of purchase records, Brigitte generates a report and either:

a) performs a use/needs analysis to identify installed software that is not required and submits a request to IT for software removal; or
b) submits a purchasing request to an IT Procurement Manager.

When Brigitte receives confirmation of the software removals and/or license purchases, she updates the software license records and generates a new compliance report showing the count for the previously under licensed software titles is now even or over.

In some embodiments True up cannot be performed during a vendor or enforcement agency audit, only self-audit.

### 8. Retire or Reallocate Surplus Software Licenses

After the baseline compliance audit or a subsequent self-audit, Brigitte identifies a number of software titles that are over licensed (i.e. proof of purchase counts far exceed the count of software installed). After ensuring that over licensing cannot be resolved by reconciling errors in proof of purchase or configuration scanning/inventory data, Brigitte generates reports identifying one or more of, but not limited to:

a) surplus software licenses that can be cancelled (e.g. subscription-based licenses) or returned for rebate, refund or credit;
b) surplus software that can be assigned to fulfill new or open requests without ordering additional licenses;
c) surplus software that can be removed from existing support and maintenance agreements, or can be removed from support and maintenance due for imminent renewal; and
d) surplus software licenses that can be removed from license agreements due for imminent renewal.

Brigitte Dee shares her findings and works with Penny Pinchar, the IT Procurement Manager, to reduce software license and support costs.

### 9. Respond to a Notification Letter of Audit

Earl Energy receives a “with cause” audit notification letter notifying Earl Energy that it must provide a report showing the software installed on all of Earl's computers at all of its locations and a review of the software licenses and proofs of purchase for those licenses for all Brand X Operating System software licenses. As per established best practice, the letter is immediately forwarded to Earl's legal counsel, Lance Chaser, who in turn requests information from Brigitte about their state of compliance. Brigitte immediately forwards Lance a Proof of Purchase Summary Report based on the most recent software and hardware inventory audit information. Lance requires the information quickly to establish the strength of Earl's legal position and determine the appropriate strategy within the two week response period specified in the notification letter. Brigitte filters the report to include only the publisher(s) and software title(s) indicated in the notification letter, i.e. Brand X Server OS, ABC.x OS and DOS licenses.

### 10. Audit Response

As a member of Earl Energy's Software Audit Response team, Brigitte works closely with legal counsel, IT procurement, the executive team and other stakeholders to gather all of the information and materials required to respond to the audit. In her role as Software Asset Manager, Brigitte is responsible for performing some or all of the following tasks:

a) performing a self-audit;
b) filtering the self-audit report to match the narrowed focus of the audit negotiated by legal counsel (scope of audit, time frame, changes to systems against all hardware devices);
c) checking proof of purchase documentation for one or more of, but not limited to, the following items: date purchased; full description of software/hardware; hardware purchase should include full description of software included; version; quantity; vendor contact information; confirm that the proof of purchase is for Earl Energy; purchase price; and proof of payment.
d) compiling the required reports and materials specified by letter filtered to the software publisher(s) and title(s) named in the letter, for example:

i) copies of proof of purchase documents for inclusion as Exhibits with the audit report;

ii) proof of purchase summary report;

iii) an audit summary report showing numbers of installations, numbers of licenses, variance, (average) unit price, total price (variance*unit price) and comments, totaled and sorted by software publisher and software title.

As noted in the notification of audit letter, Brigitte cannot reconcile any under- or over licensed software titles by deleting any instances of the named software currently installed on Earl Energy's computers, or enter into negotiations with representatives of the named publisher(s) to purchase licenses prior to the resolution of the audit. In other words, Brigitte cannot perform a License True Up or Retire or Reallocate Surplus Software Licenses until the audit is complete.

11. Reconcile Volume Agreements with Software Purchase Records

In order to ensure Earl Energy has received all the licenses it has purchased, Brigitte generates a report that compares Earl's license entitlement from a software supplier volume license services portal with Earl's software purchase records.

Where Brigitte identifies purchases in excess of the license entitlement, she may either:

a) negotiate a refund from her vendor; or
b) work with her vendor or directly with the software company to ensure the licenses are added to her entitlement.

Where Brigitte identifies a shortfall of purchases from the license entitlement, she may:

a) perform a self audit;
b) source alternate proof of purchase information; and
c) perform a license reconciliation.

The above is a specific example and it is to be understood that embodiments of the invention may deviate from the scope of the specific description above in an implementation specific manner.

### Advanced Connector

In IT service management, it is often necessary to integrate data from multiple sources into a single repository (for example a configuration management database, which is a repository of information related to all the components of an information system, including the authorized configuration of the significant components) for analysis. The data can come from diverse systems such as, but not limited to, financial systems, procurement systems, shipping and receiving systems, HR systems. The data can represent many different types of information. For example, the data may be in the form of purchase orders, invoices, employee's information, or many other types of information that may be tracked for IT service management.

The data may come from systems internal to the business and from external sources, such as suppliers or business partners.

In order to correlate the information from the source systems to the information already present in the repository or to expand the repository to include this information if it does not already exist, it is necessary to define various cleansing/parsing and mapping rules. Business rules specific to each business may need to be applied to the data to be imported in order to identify relevant issues or to manipulate the data before importing it. Examples of mappings (which may also be referred to herein as relationships or associations) and business rules are provided below.

In some embodiments, the manner in which mappings can be created or modified, or both, is by utilizing configuration files to define the mappings. In some embodiments, a user interface (UI) may be available to enable modification of the mappings.

Once data from a source input file is parsed and mapped, there can still be issues that need to be addressed by having a business user review the data and apply business judgment to determine the best course of action to address the issues with the data. For example, when an advanced shipping notification (ASN) provides a serial number for an ordered asset that already exists in the database.

Currently available technology used to perform imports into IT service management systems does not provide visibility into the import process to business users. Data is either imported or rejected as is, there is no easy way to customize business rules or report on acceptance and validity of individual items being imported. Furthermore, there is no easy facility to manipulate the business rules and mappings.

Some embodiments of the invention integrate an import phase and a reconciliation phase that can be controlled within the IT service management system, which allows the data to be modified/edited/manipulated so that it can be imported into the system and used more effectively.

In some embodiments, raw information is imported into a temporary holding place in the database. Configurable workflows are then used to apply a first level of validation and transformations to the data. In some implementations, this may involve using the business rules to implement appropriate mapping rules. Workflow is used to help automate a flow of work enterprise wide. The concept of workflow can be used to ensure that consistent business processes are in place across an enterprise.

A business user can then log into an IT management UI and review the newly imported data. In some embodiments, the user can review error data and apply corrections. In some embodiments, the user can review error data and can choose to modify the original data and resubmit the import. The user can also validate that the appropriate relationships have been established between the imported data and the data already present in the database.

In some embodiments, the definition of new import formats and configuration of the validation, transformation and mapping rules may be done in any number of ways including, but not limited to, other modules of the IT management system, designed specifically for the task at hand or that are generic and can be used for the task at hand.

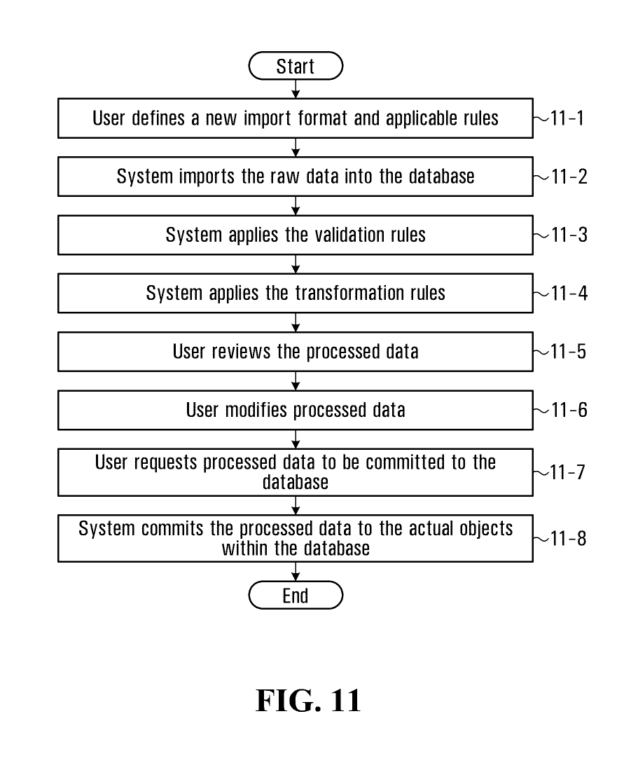

FIG. 11 will now be referred to when describing a method for importing data or inputting data, or both, to a database of an IT management system. In a first step 11-1 of the method, a user defines a new import format for storing a record in the database and applicable rules for importing raw data. In some embodiments, defining new import formats is done through a specialized module of the IT management system. In some embodiments, the user may be an individual familiar with the operation of the software, as opposed to an individual responsible for overseeing IT management for an enterprise. Alternatively, the user may be both knowledgeable about the operation of the software and IT overseeing IT asset management for an enterprise.

In a second step 11-2, the system imports the raw data into the database. In some embodiments, the raw data being imported into the database: may use a Linking Framework; may be a .CSV file import; may be imported via product-specific Application Programming Interfaces (API); may be obtained from a web services connection; or may be other types of raw data. The data may be imported as a batch into a temporary storage location in the database. In some embodiments the temporary storage space resides within the database and is accessible to an API within the IT management system. Storing the data in a temporary storage space in the database makes it possible to review and manipulate the imported data through the IT management UI before finalizing it to the database.

In a third step 11-3, the system applies validation rules. Validation rules check to make sure the data is correctly formatted and structured for use by the IT management system. Validation rules may include rules that are used to determine if aspects of the input data or imported data, or both, need to be validated or confirmed by a user. In some embodiments, a workflow is invoked for each newly created import batch and processes each batch.

In a fourth step 11-4, the system applies transformation rules. The transformation rules may include business rules that are applied based on the import type (ASN, PO, Receiving, Invoices or other data). In some embodiments, the transformation rules enable the data to be validated, cleansed, and relationships to existing data be identified. In some embodiments complex mapping is implemented in the pre-processing stage. Examples of business rules for transforming data for different scenarios are provided in further detail below.

In some embodiments, validation errors are flagged for further review by a user.

In some embodiments, workflows can be configured using authoring tools. Authoring tools are software programs aimed at allowing users to visually create and modify the configuration of workflows used by another program to process imported data.

In a fifth step 11-5, the user reviews the processed data. In some embodiments, the user may be the same user as in step 11-1 or it may be a user with a different skill set. In some implementations the user is responsible for IT management within an enterprise.

In some implementations imported batches of data are marked as “Unprocessed” and listed for the user to review. In such implementations, the user can open the batch and review each line item in the import. Each line may be marked as “valid” or “invalid” according to the business rules.

In a sixth step 11-6, the user modifies processed data. The user can edit the data in the imported line items (i.e. adjusting a make/model to fit the hardware catalogue entries, add the warranty information, etc.).

In a seventh step 11-7, the user requests that processed data be committed to the database. When a user is satisfied that the data in the batch is accurate, the user can select to have the batch applied to the database. If some line items in the batch are still “invalid”, the user may choose to apply the batch anyways. In some implementations the batch may be marked as “partially processed” and the user may be able to complete the validation process and apply the remaining line items at a later time. In some implementations, the data updates are applied using a configurable workflow, which allows for additional business rules processing at this stage.

In an eighth step 11-8, the processed data is committed to the actual objects/records within the database. In some embodiments, pre and post processing workflows can be configured using other modules in the IT management system. In some embodiments, the forms used to review and edit the import batch can be customized using other modules in the IT management system.

In some embodiments an IT management system according to aspects of the invention described herein include a processor and a computer readable memory. The computer readable memory includes software modules including computer executable instructions and a database for storing data input to the IT management system. The software modules including computer executable instructions, when executed by the processor, perform at least one of the following functionalities: importing data into temporary storage in the database; applying validation rules; applying transformation rules; allowing a user to review processed data; allowing the user to modify the processed data; once the user has requested that the processed data be committed to the database, committing the processed data to records in the database.

Another aspect of the invention includes a computer-readable medium comprising computer executable instructions, which when executed by a processor perform at least one of the following functionalities: importing data into temporary storage in the database; applying validation rules; applying transformation rules; allowing a user to review processed data; allowing the user to modify the processed data; once the user has requested that the processed data be committed to the database, committing the processed data to records in the database.

A computer readable medium may include a physical medium such as a CD, DVD, computer hard drive, computer random access memory (RAM), read-only memory (ROM) or other conventional means of storing computer readable information in a computer or on a medium to be read and loaded onto a computer.

Examples of Data being Input/Imported Using Advanced Connector and Business Rules and Mappings Associate with the Input/Import Process

In a first example of information being imported using the Advanced Connector, the information is imported from an input file including a purchase order (PO). The PO is generated by an entity when the entity wishes to acquire an asset. The PO document may have some of the following data fields: purchase order number; request number; requestor last name; requestor first name; supplier; creation date; cost center number; general ledger (GL) account number; manufacturer part number; item description; quantity; and price. These are just examples of data fields that could be included in the PO. In some situations there may be other data fields that are not included in the listing above, or in some cases not all of the data fields above may be included. The data fields in any given PO are implementation specific.

The following are a selection of business rules that can be applied to generate a PO record to be stored in the database based on the PO.

### Business Rule #1

A PO data record can be created from information in the input file including the PO based on the following associations:

| Field | Source of Data |
|---|---|
| PO Number | Input File - PO Number |
| Status | Static value: “Ordered” |
| Request Number | Input File - Request Number |
| PO Creation Date | Input File - Creation Date |
| GL Account Number | Input File - GL Account |
| | Number |

### Business Rule #2

The following relationships may be created for the new PO record:

| Relationship | Source of Data |
|---|---|
| Supplier | Supplier identified using a |
| | supplier field in the input |
| | PO file. If a supplier cannot |
| | be identified, the purchase |
| | order may be marked |
| | “invalid”. |
| User (Requestor) | User identified using the |
| | first and last name fields in |
| | the input PO file. If the |
| | user cannot be identified, |
| | the purchase order may be |
| | marked “invalid”. |
| Cost Centre | Cost centre identified using |
| | the supplier field in the |
| | input PO file. If a cost |
| | centre cannot be identified, |
| | the purchase order may be |
| | marked “invalid”. |

### Business Rule #3

PO record line items may be created for each row from the input file PO based on the following information:

| Field | Source of Data |
|---|---|
| Manufacturer Part | Input File - Manufacturer |
| Number | Part Number |
| Item Description | Input File - Item Description |
| Quantity | Input File - Quantity |
| Price | Input File - Price |

The above discussed business rules are an example of a specific set of business rules pertaining to generating a PO data record from an input PO file. It is to be understood that these are not the only business rules that may apply to such a process. In some implementations, additional business rules not disclosed herein may also apply. Furthermore, it is to be understood that a PO data record may contain additional fields or fewer fields than the specific example above.

### Advanced Shipping Notification

An Advanced Shipping Notification (ASN) is received periodically from a supplier and presents the information about one or more assets that have been shipped. This document may represent the first time a serial number of the one or more ordered assets is received and allows the asset records to be created based on the serial number.

A second example of information being imported using the Advanced Connector involves importing from an input file including the ASN. The ASN may have some of the following data fields: PO number; order number; shipping date; supplier part number; description; manufacturer; manufacturer part number and serial number.

The following are a selection of business rules that may be applied to generate an ASN record to be stored in the database based on the input file ASN document.

### Business Rule #1

If there is an existing asset record in the database with the same serial number, the line item from the document/shipping notice will be marked as invalid.

### Business Rule #2

For each item in the input file ASN document, an asset record may be created with the following information:

| Field | Source of Data |
|---|---|
| Serial Number | Input File - Serial Number |
| Lifecycle Status | Static value: “Shipped” |
| Description | Input File - Description |

### Business Rule #3

The following relationships may be established for the new asset record:

| Relationship | Source of Data |
|---|---|
| Purchase Order | PO identified by PO Number |
| | field in the input APN file. |
| | If no PO found, a new one is |
| | created. |
| Hardware | The manufacturer part number |
| Catalogue Item | field in the input file APN |
| | may be used to find a |
| | matching hardware catalogue |
| | item. If no hardware |
| | catalogue item is found, the |
| | field may be flagged for |
| | review. The user reviewing |
| | the data may have an option |
| | to approve creation of a new |
| | hardware catalogue item. The |
| | mappings used to create the |
| | new hardware catalogue item |
| | are described below. |
| Cost Center | The asset will be related to |
| | the same cost centre as the |
| | purchase order identified |
| | previously. |

### Business Rule #4

If a new hardware catalogue record is to be created, the following mappings may be used:

| Field | Source of Data |
|---|---|
| Make and Model | Input File - Description |
| Status | Static value: “Pending” |
| Manufacturer Part | Input File - Manufacturer |
| Number | Part Number |
| Description | Input File - Description |

### Business Rule #5

If a new hardware catalogue record is created, the following relationship may be established:

| Relationship | Source of Data |
|---|---|
| Manufacturer | Manufacturer identified using |
| | the manufacturer field in the |
| | input APN file. If a |
| | manufacturer cannot be |
| | identified, the field may be |
| | flagged for review and the |
| | user reviewing the data may |
| | confirm that a new |
| | manufacturer will be created. |

### Business Rule #6

If a manufacturer record is to be created, the following mappings may be used:

| Field | Source of Data |
|---|---|
| Name | InputFile - Manufacturer |
| Status | Static value: “Pending” |

The above discussed business rules are an example of a specific set of business rules pertaining to generating an APN data record from an input APN file. It is to be understood that these are not the only business rules that may apply to such a process. In some implementations additional business rules not disclosed herein may also apply. Furthermore, it is to be understood that an APN data record may contain additional fields or fewer fields than the specific example above.

### Receiving Report

A receiving report is generated upon receipt of ordered assets. This document is a confirmation of the ordered assets that have been received.

A third example of information being imported using the Advanced Connector involves importing from an input files including a receiving report. The receiving report may have some of the following data fields: serial number; manufacturer; manufacturer part number; model; serial number; asset tag and location code.

The following are a selection of business rules that may be applied to update records that have been previously generated or provide an indication that there is an error in the received assets.

### Business Rule #1

If an asset with the serial number identified in the receiving report having a status of “ordered” or “shipped” cannot be found, the field may be marked as “invalid”.

### Business Rule #2

If the asset is found, it may be updated in the following manner:

| Field | Source of Data |
|---|---|
| Lifecycle Status | Static value: “Received” |
| Asset Tag | Input File - Asset Tag |

### Business Rule #3

The following relationships may be established for the asset:

| Relationship | Source of Data |
|---|---|
| Location | Location identified by |
| | location code field in the |
| | input receiving report file. |
| | If no location is found, mark |
| | field as invalid. |

The above discussed business rules are an example of a specific set of business rules pertaining to generating a receiving report data record from an input receiving report file. It is to be understood that these are not the only business rules that may apply to such a process. In some implementations, additional business rules not disclosed herein may also apply. Furthermore, it is to be understood that a PO data record may contain additional fields or fewer fields than the specific example above.

### Invoice

An invoice is a bill from a supplier requesting payment for the ordered assets. This document may be compared to the Receiving Report to verify the payment due.

A fourth example of information being imported using the Advanced Connector involves importing from an input file including an invoice. The invoice may have some of the following data fields: invoice number; invoice date; order number; PO number; invoice line number; supplier part number; manufacturer; description; quantity and amount.

As with the receiving report, business rules may be applied to update records that have been previously generated or provide an indication that there is an error in the received assets.

A particular implementation in which the advanced connector may find use is with Microsoft System Center Service Manager. The Microsoft System Center Service Manager platform imports purchase related data (ASN, PO, invoice) without the ability to modify the data. The purchase related data is not in a form that it is compatible to be used with information that is obtained by deployment scanning software and input or imported into a Configuration Management database of the Microsoft System Center Service Manager platform. The advanced connector, because of its ability to import the data and modify within the operation of the Microsoft System Center Service Manager platform is seen to be particularly advantageous, providing a functionality that is not currently in the platform, while extending the ability of the platform with data already available to the platform.

Some embodiments of the invention allow a user to create and edit license agreement data entry. The license agreement data entry may track one or more of the following information: license ID; vendor license ID; SKU; license agreement ID; license product ID; license invoice ID; license line item number; license alternate proof of purchase ID; license quantity; license invoice status; license purchase date; install key; license key; support and maintenance information; contract ID; license effective date; and license end date.

Some embodiments of the invention allow a user to import enterprise license agreement information in the form of information from software supplier volume licensing services and create a license agreement data entry. The information may be imported via XML from a VLS portal or from a .CSV file in a predetermined format. Source information may be imported to the appropriate destination fields in the license agreement data entry and software license data entries.

Some embodiments of the invention allow a user to create and edit software license data entries. The software license data entry may track one or more of the following information: license ID; vendor license ID; SKU; license agreement ID; license product ID; license invoice ID; license line item number; license alternate proof of purchase ID; license quantity; license invoice status; license purchase date; install key; license key; support and maintenance information; contract ID; license effective date; and license end date.

Some embodiments of the invention allow a user to create and edit create and edit a software item data entry. The software item data entry may track one or more of the following information: publisher, software title, version, license ID; and SKU.

Some embodiments of the invention allow a user to create and edit a license conditions data entry. The license conditions data entry may track one or more of the following information: condition license ID; license condition name; license condition linking; license condition alias; license condition data entry; license condition operator; license condition variable; license condition description; and license condition documentation.

Some embodiments of the invention allow a user to select, import, edit (as required) and associate with a software license a previously defined set of license conditions.

Some embodiments of the invention allow a user to import invoice detail required to provide proof of purchase for license compliance from a .CSV file or directly from a finance system.

Some embodiments of the invention allow a user to manually create, edit and associate a proof of purchase data entry with a software license data entry. The proof of purchase data entry may include one or more of the following information: type of alternate proof, e.g. vendor or publisher provided purchase summary, certificate of authenticity, credit card or cash register receipt, or cancelled cheque, vendor ID and location, e.g. physical location, URL or file system location and/or attached document.

Some embodiments of the invention allow a user to import a purchasing summary report from a vendor or publisher provided .CSV file, or from a .CSV or .XML file from the VLS portal and associate the record with a software license.

Some embodiments of the invention allow a user to attach a document file, insert a link to a file, and/or specify the physical location of hard copies for the following: software agreements; software license condition; software maintenance/support agreements; invoices; alternate proofs of purchase.

Some embodiments of the invention allow a user to specify the location of both originals and copies of physical software installation media. The user may be able to specify whether the location information is for images, file locations, download locations or other types of information.

Some embodiments of the invention allow a user to generate a display license documentation and purchase summary. The summary is a spreadsheet report that details the total number of each licensed product that the company is contracted to have in its position. It may detail the following: software publisher name; versions or releases of each product under licensed agreement; number of licenses present; proofs of purchase.

Some embodiments of the invention allow a user to display a list of hardware that is not detected by automated configuration scanning that requires a physical audit. The user can see most recently available software configuration information (if available), status of hardware and physical location.

Some embodiments of the invention allow a user to generate proof of purchase summary report. The report may be a row and column report sorted by publisher and title/version containing the following columns: Publisher; Software title/version; count of software instances found configured (installed) on systems by software title/version; count of software licenses with proofs of purchase by title/version; column sub-totals by publisher; Short/Even/Over quantity, i.e. the shortfall or excess of proofs of purchase to configured instances.

Some embodiments of the invention allow a user to generate an audit summary report. The report may be a row and column report sorted by publisher and title/version containing some or all of the following columns: publisher; software title/version; number of installations (count of software instances found configured (installed) on systems by software title/version); number of licenses (count of software licenses with proofs of purchase by title/version); variance (Short/Even/Over quantity), i.e. the shortfall or excess of proofs of purchase to configured instances; unit price (average purchase price per title/version); and total price (variance*unit price.

In some embodiments of the invention, the advanced connector may be used in an IT asset management system having an architecture as described above in FIG. 3.

In some embodiments of the invention, the import connectors, user interfaces for manual input of data, software mapping tools, rule builder tools and software title mapping tools and any graphical user interfaces that may be used in connection with those aspects of the invention, for example described with reference to FIGS. 3, 6, 7A, 7B, 8, 9A to 9D and 10, are implemented as algorithms and/or computer-readable instructions in any desirable computer programming language.

Numerous modifications and variations of the present invention are possible in light of the above teachings. It is therefore to be understood that within the scope of the appended claims, the invention may be practised otherwise than as specifically described herein.

1. A method of monitoring software licensing compliance comprising:
inputting data pertaining to software into a database;
performing software product mapping for software product data input to the database;
performing usage rights rule building for usage rights data input to the database;
performing software title mapping for software title data input to the database;
determining software compliance as a function of data input to the database and mappings that are performed on the data.

2. The method of claim 1 wherein usage rights comprise any one or more of: data related product use rights (PUR), laws, industry regulations and organizational policies that fall outside the realm of an end user licensing agreement for one or more pieces of software.

3. The method of claim 1 wherein performing usage rights rule building for usage rights data input to the database comprises:
building rules for importing or inputting usage rights data, which is in an unstructured record format, that enables converting the unstructured record format into a format that is more acceptable than the unstructured record format for correlating with other data stored in the database.

4. The method of claim 1 wherein inputting data into the database comprises inputting or importing, or both, data related to a purchase of information technology (IT) assets.

5. The method of claim 4 wherein data related to a purchase of IT assets comprises one or more of: an advanced shipping notification (ASN); a purchase order (PO); an invoice; data transferred from financial management systems, a credit card receipt, a cancelled check and a cash register receipt.

6. The method of claim 4 wherein data related to a purchase of IT assets comprises information pertaining to one or more of: a publisher of software purchased, a title of software purchased, a version of software purchased, a part number, a purchased quantity, a date of purchase, a unit price and a supplier.

7. The method of claim 1 wherein inputting data into the database comprises inputting of data related to the entitlement of the licensee.

8. The method of claim 7 wherein data related to the entitlement of the licensee comprises information related to at least one of: a volume agreement; a software support agreement and a maintenance agreement.

9. The method of claim 1 wherein inputting data into the database comprises inputting or importing, or both, data related to the deployment of software or hardware, or both, in an enterprise network.

10. The method of claim 9 wherein data related to the deployment of software or hardware comprises data that is an inventory of software or hardware, or both, installed on computers or assigned to users in the licensee's environment.

11. The method of claim 1 wherein performing software product mapping for software product data input to the database comprises at least one of:
mapping the software product data to data records that are already stored in the database; or
creating new data records in the database based on the input/imported software product data.

12. The method of claim 1 wherein performing software title mapping for software title data input to the database comprises:
configuring data that is collected either automatically by software inventory, discovery or configuration management software, or manually through physical inventory and imported/input to the database;
mapping the configured data to a standardized list indicating the publisher, title and version of the software products.

13. The method of claim 1 wherein the method of monitoring software licensing compliance is included in one of:
an IT service management system; and
a software asset management system.

14. An IT management system comprising:
a processor;
a computer-readable memory comprising:
software modules including computer executable instructions, which when executed by the processor perform the following functionalities:
inputting data pertaining to software into a database;
performing software product mapping for software product data input to the database;
performing usage rights rule building for usage rights data input to the database;
performing software title mapping for software title data input to the database;
determining software compliance as a function of data input to the database and mappings that are performed on the data;
a database for storing data input to the IT management system.

15. The IT management system of claim 14, wherein the software modules perform the method steps of any one of claims 2 to 13.

16. A computer-readable medium comprising computer executable instructions, which when executed by a processor perform the following functionalities:
inputting data pertaining to software into a database;
performing software product mapping for software product data input to the database;
performing usage rights rule building for usage rights data input to the database;
performing software title mapping for software title data input to the database;
determining software compliance as a function of data input to the database and mappings that are performed on the data.

17. The computer-readable medium of claim 16, wherein the computer executable instructions, when executed by a processor, perform the method steps of any one of claims 2 to 13.

18. A method of inputting or importing data into a database in an IT service management system, the method comprising:
the system importing the data into temporary storage in the database;
the system applying validation rules;
the system applying the transformation rules;
the user reviewing the processed data;
the user modifying the processed data;
the user requests that the processed data be committed to the database;
the system committing the processed data to records in the database.

19. The method of claim 18 further comprising:
a user defining a new import format for storing a record in the database and applicable rules for importing the data.

20. The method of claim 18 wherein importing the data into temporary storage in the database comprises importing the data as a batch into the temporary storage in the database.

21. The method of claim 19 wherein defining a new import format for storing a record in the database and applicable rules for importing the data is done through a specialized module of the IT service management system.

22. The method of claim 18 wherein importing the data into temporary storage in the database comprises importing the data using a Linking Framework, CSV Import, product-specific Application Programming Interfaces (API), a Web Services connection, or by other means.

23. The method of claim 18 wherein applying validation rules comprises flagging validation errors.

24. The method of claim 18 wherein steps performed by a user are enabled by workflow processes.

25. The method of claim 24 wherein the workflow processes are configured through a specialized module of the IT service management system.

26. The method of claim 18 wherein the user requesting that the processed data be committed to the database further comprises:
if some data is invalid, the user choosing to apply the batch despite the error.

27. The method of claim 18 wherein importing the data comprises importing any one or more of: advance shipping notice (ASN) information, purchase order (PO) information; invoice information; and receiving report information.

28. The method of claim 18 wherein the IT service management system is Microsoft System Center Service Manager.

29. An IT management system comprising:
a processor;
a computer-readable memory comprising:
software modules including computer executable instructions, which when executed by the processor perform the following functionalities:
importing data into temporary storage in the database;
applying validation rules;
applying transformation rules;
allowing a user to review processed data;
allowing the user to modify the processed data;
once the user has requested that the processed data be committed to the database, committing the processed data to records in the database.

30. The IT management system of claim 14, wherein the software modules perform the method steps of any one of claims 18 to 28.

31. A computer-readable medium comprising computer executable instructions, which when executed by a processor perform the following functionalities:
importing data into temporary storage in the database;
applying validation rules;
applying transformation rules;
allowing a user to review processed data;
allowing the user to modify the processed data;
once the user has requested that the processed data be committed to the database, committing the processed data to records in the database.

32. The computer-readable medium of claim 31, wherein the computer executable instructions, when executed by a processor, perform the method steps of any one of claims 18 to 28.
